(19) United States
(12) Patent Application Publication
(10) Pub. No.: US 2018/0090002 A1
(43) Pub. Date: Mar. 29, 2018

(54) DISPLAY CONTROL APPARATUS, DISPLAY DEVICE, AND DISPLAY CONTROL METHOD

(71) Applicant: MITSUBISHI ELECTRIC CORPORATION, Tokyo (JP)

(72) Inventors: Hidekazu ARITA, Tokyo (JP); Mitsuo SHIMOTANI, Tokyo (JP)

(73) Assignee: MITSUBISHI ELECTRIC CORPORATION, Tokyo (JP)

(21) Appl. No.: 15/567,926

(22) PCT Filed: Aug. 3, 2015
(86) PCT No.: PCT/JP2015/071926

§ 371 Date: Oct. 19, 2017

(51) Int. Cl. G08G 1/0967; G08G 1/0962; G02B 27/01

(52) U.S. Cl. CPC G08G 1/09675; G08G 1/09626; G02B 2027/014; G02B 2027/0141; G02B 27/0101

(57) ABSTRACT

An object of the present invention is to provide a technique that enables to adequately alert a driver to an attention target. The display control apparatus is provided with: an information acquisition unit for acquiring attention information that includes at least any one of a property of an attention target to which a driver of a vehicle that is traveling should be alerted, a relative position and a relative direction, with respect to the vehicle, of the attention target; and a control unit. The control unit controls, on the basis of the attention information acquired by the information acquisition unit, at least a virtual image distance from between the virtual image distance and a virtual image direction of a corresponding display object that is a display object corresponding to the attention target.

### TECHNICAL FIELD

The present invention relates to a display control apparatus that controls a virtual image display unit, a display control method, and a display device that is provided with the display control apparatus.

### BACKGROUND ART

There are proposed various techniques related to a Head Up Display (HUD) that displays an image on a windshield of a vehicle. There is proposed, for example, an HUD for displaying an image of a virtual image that is seen by a driver as if the virtual image were existing in an actual scenery ahead of a vehicle. In addition, for example, patent document 1 proposes a HUD that changes, according to a vehicle speed, a distance (virtual image distance) between an apparent position of an image of a virtual image and a driver.

### PRIOR ART DOCUMENTS

### Patent Documents

Patent Document 1: Japanese Patent Application Laid-Open No. Hei 6-115381 (1994)

### SUMMARY OF INVENTION

### Problems to be Solved by the Invention

However, in the above-described prior art in which an image of a virtual image is displayed, it is not possible to adequately alert a driver who is driving a vehicle to attention targets such as persons and bicycles.

Accordingly, the present invention has been made taking the problem such as that described above into consideration, and an object of the present invention is to provide a technique that does not always present a display object at the optimum virtual image distance with respect to an attention target, but enables to adequately alert a driver to the attention target.

### Means for Solving the Problems

The display control apparatus according to the present invention is a display control apparatus that controls a virtual image display. The virtual image display is capable of displaying a display object, which is a virtual image that can be visually recognized from a driver seat of a vehicle through a windshield of the vehicle, at a virtual image position that is defined by a virtual image direction that is a direction of the virtual image with respect to a specific position of the vehicle, and by a virtual image distance that is a distance to the virtual image with respect to the specific position. The display control apparatus is provided with: an information receiver for acquiring attention information that includes at least any one of a property of an attention target to which a driver of the vehicle that is traveling should be alerted, a relative position and a relative direction, with respect to the vehicle, of the attention target; and a controller for controlling displaying by the virtual image display. The controller controls, on the basis of the attention information acquired by the information receiver, at least a virtual image distance from between the virtual image distance and a virtual image direction of a corresponding display object that is a display object corresponding to the attention target.

### Effects of the Invention

According to the present invention, at least a virtual image distance of a corresponding display object corresponding to an attention target is controlled on the basis of attention information. Therefore, presenting the corresponding display object (display object) corresponding to the attention target at the optimum virtual image distance enables to adequately alert a driver to the attention target.

The purpose, features, modes and advantages of the present invention will be more apparent by the following detailed descriptions and accompanying drawings.

### BRIEF DESCRIPTION OF DRAWINGS

FIG. 1 is a block diagram illustrating a configuration of a display control apparatus according to a first embodiment.

FIG. 2 is a drawing illustrating a display object according to the first embodiment.

FIG. 3 is a block diagram illustrating a configuration of a display device according to a second embodiment.

FIG. 4 is a flowchart showing the operation of the display device according to the second embodiment.

FIG. 5 is a drawing illustrating the operation of the display device according to the second embodiment.

FIG. 6 is a drawing illustrating displaying by the display device according to the second embodiment.

FIGS. 7A and 7B are drawings illustrating displaying by the display device according to the second embodiment.

FIG. 8 is a drawing illustrating displaying by the display device according to the second embodiment.

FIGS. 9A and 9B are drawings illustrating displaying by the display device according to the second embodiment.

FIG. 10 is a drawing illustrating displaying by a display device according to a first modified example.

FIGS. 11A and 11B are drawings illustrating displaying by the display device according to the first modified example.

FIG. 12 is a drawing illustrating displaying by a display device according to a second modified example.

FIGS. 13A and 13B are drawings illustrating displaying by the display device according to the second modified example.

FIGS. 14A and 14B are drawings illustrating displaying by a display device according to a third embodiment.

FIG. 15 is a drawing illustrating displaying by a display device according to a fourth embodiment.

FIGS. 16A and 16B are drawings illustrating displaying by a display device according to a fifth embodiment.

FIGS. 17A and 17B are drawings illustrating displaying by a display device according to a sixth embodiment.

FIGS. 18A and 18B are drawings illustrating displaying by the display device according to the sixth embodiment.

FIGS. 19A and 19B are drawings illustrating displaying by the display device according to the sixth embodiment.

FIGS. 20A and 20B are drawings illustrating displaying by a display device according to a seventh embodiment.

FIGS. 21A and 21B are drawings illustrating displaying by the display device according to the seventh embodiment.

FIGS. 22A and 22B are drawings illustrating displaying by a display device according to a fifth modified example.

FIGS. 23A and 23B are drawings illustrating displaying by the display device according to the fifth modified example.

FIGS. 24A and 24B are drawings illustrating displaying by a display device according to an eighth embodiment.

FIGS. 25A and 25B are drawings illustrating displaying by a display device according to a sixth modified example.

FIG. 26 is a block diagram illustrating an example of a hardware configuration of a display control apparatus.

FIG. 27 is a block diagram illustrating an example of a hardware configuration of the display control apparatus.

### DESCRIPTION OF EMBODIMENTS

### First Embodiment

The following description is based on the assumption that a vehicle is equipped with a display control apparatus according to a first embodiment of the present invention. In addition, the vehicle that is equipped with the display control apparatus, and to which attention is paid, will be described as an “own vehicle”.

FIG. 1 is a block diagram illustrating a configuration of the display control apparatus according to the present first embodiment. A display control apparatus 1 shown in FIG. 1 controls a virtual image display unit 21 having, for example, a display function of a HUD.

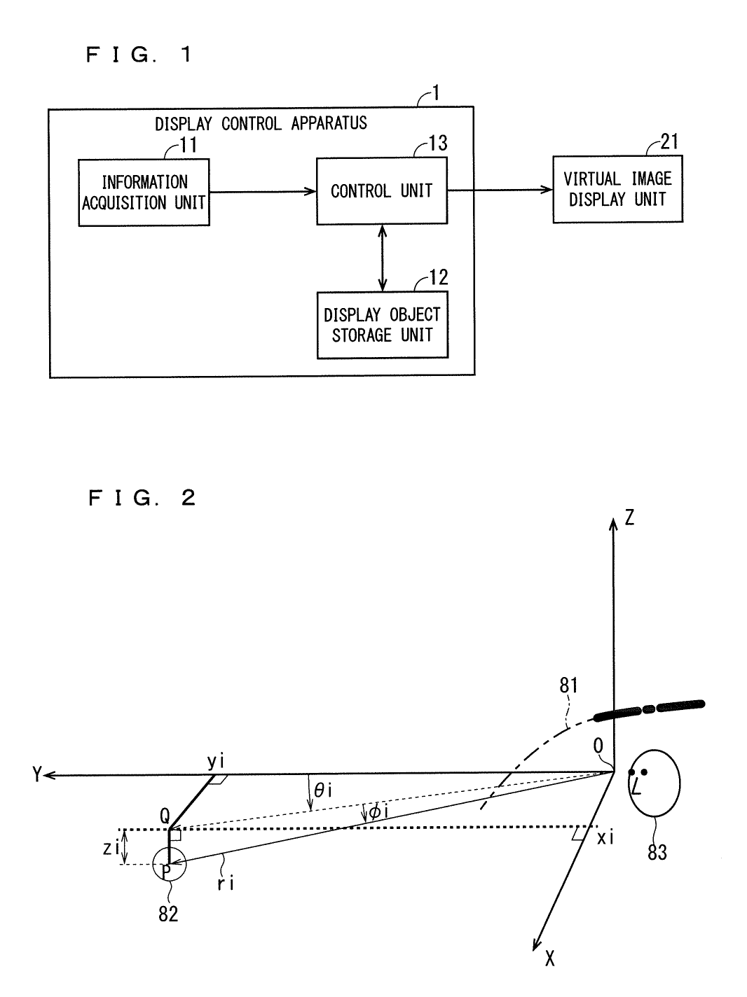

FIG. 2 is a drawing illustrating a display object 82 that is displayed by the virtual image display unit 21. The virtual image display unit 21 is capable of displaying the display object 82 which is a virtual image that can be visually recognized from a driver seat of an own vehicle through a windshield 81 of the own vehicle. The display object 82 is actually displayed at a position on the windshield 81. However, the display object 82 is adapted to be seen by a driver as if the display object 82 were existing at a virtual image position. Here, the virtual image position is defined by a virtual image direction and a virtual image distance.

The virtual image direction is a direction of a virtual image (the display object 82) with respect to a specific position (for example, the driver seat or the windshield 81) of the own vehicle. The virtual image direction substantially corresponds to a position of the display object 82 on the windshield 81 (substantially two-dimensional plane) viewed from a driver 83, and is represented by, for example, a deflection angle θi and an elevation angle φi in a three-dimensional polar coordinate system. Needless to say, if polar-to-orthogonal coordinate conversion is performed, the virtual image direction can also be represented even in an orthogonal coordinate system.

The virtual image distance is a distance to the virtual image (the display object 82) with respect to a specific position (for example, the driver seat or the windshield 81) of the own vehicle. The virtual image distance substantially corresponds to a distance in a far-and-near direction to the display object 82 viewed from the driver 83, and is represented by, for example, a moving radius (ri) or the like in the three-dimensional polar coordinate system. Strictly speaking, a distance between the display object 82 and the driver 83 on the same plane differs depending on the deflection angle θi and the elevation angle φi for each display object 82. However, when the distance in the far-and-near direction is sufficiently far, the difference in distance caused by the deflection angle θi and the elevation angle φi can be ignored. Here, when a position of eyes of the driver 83 is treated as an original point, the forward direction of the own vehicle is defined as a Y axis, the left direction of the own vehicle is defined as an X axis, and the upward direction of the own vehicle is defined as a Z axis. Therefore, a position Pi of the display object 82 is represented by (xi, yi, zi) in the orthogonal coordinate system. In this case, the following relational expressions hold: ri=(xi²+yi²+zi²)^{1/2}, tan(θi)=xi/yi, tan(φi)=zi/(xi²+yi²)^{1/2}. In order to simplify the description below, it is assumed that yi>>xi, yi>>zi, in other words, the display object 82 is sufficiently far from the own vehicle. In this case, the following relational expressions holds: ri≈yi, tan(θi)=xi/yi, tan(φi)≈zi/yi.

By aligning a focus distance of own eyes of the driver 83 with a virtual image distance, the driver 83 is capable of visually recognizing the display object 82 at the virtual image position represented by three-dimensional polar coordinates (ri, θi, φi) or the like. Here, the focus distance of eyes of the driver 83 is represented by xd=ri≈yi.

Returning to FIG. 1, the display control apparatus 1 is provided with an information acquisition unit 11, a display object storage unit 12, and a control unit 13. It should be noted that for example, the undermentioned memory applies to the display object storage unit 12. For example, as described below, a processor executes a program stored in a memory, thereby realizing the information acquisition unit 11 and the control unit 13.

Next, components of the display control apparatus 1 will be each described.

The information acquisition unit 11 acquires attention information that includes at least any one of (i) a property of an attention target to which a driver of a traveling own vehicle should be alerted, (ii) a relative position and (iii) a relative direction, with respect to the own vehicle, of the attention target.

Configuration in which attention information includes a relative position and a relative direction of an attention target

First of all, a configuration in which the information acquisition unit 11 acquires attention information that includes a relative position or a relative direction of an attention target with respect to the own vehicle will be described. Here, various physical objects or points apply to the attention target as described below.

First Example of Attention Target

In the first example of the attention target, a moving object around the own vehicle (a motorbike, an other vehicle, or a person, etc.), and a non-moving object around the own vehicle (an obstacle or a falling object on a road, etc.) apply to the attention target. It should be noted that in the description below, as a matter of convenience, the moving object and the non-moving object may be collectively called “attention target object”. For example, a millimeter-wave radar, a DSRC (Dedicate Short Range Communication) unit, an image processing device that processes an image of a camera (for example, an infrared camera), and the like in the own vehicle detect a relative position or a relative direction of an attention target object around the own vehicle (forward, sideward, backward) with respect to the own vehicle. The information acquisition unit 11 acquires the detection result (the relative position or the relative direction of the attention target with respect to the own vehicle).

The information acquisition unit 11 acquires (generates) attention information that includes, as the relative position or the relative direction of the attention target, the acquired detection result, in other words, the relative position or the relative direction of the attention target around the own vehicle with respect to the own vehicle. It should be noted that although the information acquisition unit 11 has been described here as a unit provided separately from the above-described millimeter-wave radar and the like, the present invention is not limited to this, and thus the information acquisition unit 11 may include the above-described millimeter-wave radar or the like. In addition, the information acquisition unit 11 has only to acquire the relative position or the relative direction of the attention target object with respect to the own vehicle as the result. For example, the information acquisition unit 11 may be configured to calculate the relative position or the relative direction of the attention target object with respect to the own vehicle on the basis of an absolute position of the attention target object and an absolute position of the own vehicle.

Second Example of Attention Target

In the second example of the attention target, among a plurality of attention target points set beforehand as points to which a driver of the traveling own vehicle should be alerted, an attention target point around the own vehicle applies to the attention target. The information acquisition unit 11 acquires a current position of the own vehicle and map information from, for example, a position detector such as a GPS (Global Positioning System) receiver that detects a current position (for example, latitude and longitude) of the own vehicle, and a storage unit that stores map information having a plurality of attention target points set therein. On the basis of the current position and the map information that have been acquired, the information acquisition unit 11 calculates a relative position or a relative direction, with respect to the own vehicle, of an attention target point around the current position of the own vehicle.

The information acquisition unit 11 acquires (generates) attention information that includes the calculated relative position or the calculated relative direction of the attention target point around the own vehicle as the relative position or the relative direction of the attention target. It should be noted that although the information acquisition unit 11 has been described here as a unit provided separately from the above-described position detector and the like, the present invention is not limited to this, and thus the information acquisition unit 11 may include the above-described position detector or the like. In addition, the information acquisition unit 11 has been described here as a unit that calculates the relative position or the relative direction, with respect to the own vehicle, of the attention target point around the own vehicle. However, the present invention is not limited to this. The calculation may be performed outside the information acquisition unit 11, and the information acquisition unit 11 may be configured to acquire the calculation result from the outside.

For example, an accident-prone point, a point in a situation in which the frequency of occurrence of accidents is high, a point on a school-commuting road at the specific time, a point of a tunnel exit in which a strong wind blows, or the like applies to an attention target point set in the map information. The attention target point may be set before shipment, or may be set after shipment on the basis of the operation of a user or information transmitted from a VICS (Vehicle Information and Communication System) (registered trademark). In addition, it is not absolutely necessary to store map information having attention target points set therein. An attention target point may be acquired as appropriate by using, for example, a communication device.

Third Example of Attention Target

In the third example of the attention target, among the attention target points in the second example of the attention target, an attention target point related to expressways (hereinafter referred to as “expressway attention target point”) applies to the attention target. As with the second example of the attention target, when an expressway attention target point applies to the attention target, the information acquisition unit 11 acquires a current position of the own vehicle and map information from the position detector and the storage unit. In addition, the information acquisition unit 11 acquires a guide route of the own vehicle from a navigation device that guides the own vehicle along the guide route. On the basis of the current position, the guide route and the map information that have been acquired, the information acquisition unit 11 calculates respective relative positions, with respect to the own vehicle, of two or more expressway attention target points, at which the own vehicle can arrive by traveling along the guide route, among the plurality of expressway attention target points.

The information acquisition unit 11 acquires (generates) attention information that includes the calculated relative positions of the two or more expressway attention target points as relative positions of two or more attention targets. It should be noted that although the information acquisition unit 11 has been described here as a unit provided separately from the above-described navigation device and the like, the present invention is not limited to this, and thus the information acquisition unit 11 may include the above-described navigation device or the like. In addition, the information acquisition unit 11 has been described here as a unit that calculates the respective relative positions, with respect to the own vehicle, of the expressway attention target points. However, the present invention is not limited to this. The calculation may be performed outside the information acquisition unit 11, and the information acquisition unit 11 may be configured to acquire the calculation result from the outside.

It should be noted that, for example, an interchange, a junction, a service area, a parking area or the like of the expressway applies to the expressway attention target point.

Configuration in Which Attention Information Includes a Property of an Attention Target

In the above description, the configuration in which the information acquisition unit 11 acquires attention information that includes a relative position or a relative direction of an attention target with respect to the own vehicle has been described. Next, a configuration in which the information acquisition unit 11 acquires attention information that includes a property of an attention target will be described. In such a configuration, for example, attention information includes, as a property of an attention target, an attention degree indicating a degree to which a driver should be alerted to the attention target around the own vehicle.

For example, in a configuration in which an attention target is any of a person, a motorbike, an other vehicle, and a non-moving object that is not these moving objects, the image processing device analyzes an image, around the own vehicle, image-captured by a camera. In addition, when the image processing device acquires an analysis result indicating that the image includes an attention target that is any of a person, a motorbike, an other vehicle and a non-moving object, the information acquisition unit 11 determines an attention degree on the basis of the analysis result of the image processing device.

For example, when the information acquisition unit 11 acquires a determination result indicating that the attention target is a person, the information acquisition unit 11 determines a high attention degree, and when the information acquisition unit 11 acquires a determination result indicating that the attention target is a non-moving object, the information acquisition unit 11 determines a low attention degree. The information acquisition unit 11 acquires (generates) attention information that includes the determined attention degree. It should be noted that although the information acquisition unit 11 has been described here as a unit provided separately from the above-described image processing device, the present invention is not limited to this, and thus the information acquisition unit 11 may include the above-described image processing device. In addition, the information acquisition unit 11 has been described here as a unit that determines the attention degree. However, the present invention is not limited to this. The determination may be made outside the information acquisition unit 11, and the information acquisition unit 11 may be configured to acquire the determination result from the outside.

The information acquisition unit 11 has been described as above. Next, components other than the information acquisition unit 11 will be described.

The display object storage unit 12 stores a plurality of display objects. The plurality of display objects includes, for example, a warning object indicating a warning mark or the like, and a signboard object indicating a simplified drawing, a road traffic sign or the like of an expressway.

The control unit 13 integrally controls each component of the display control apparatus 1, and controls displaying by the virtual image display unit 21.

As one control related to displaying by the virtual image display unit 21, the control unit 13 controls the virtual image display unit 21 to display a display object or the like stored in the display object storage unit 12. For example, when an attention target is an attention target object (a moving object, a non-moving object) or an attention target point, the control unit 13 causes the virtual image display unit 21 to display the above-described warning object as a display object corresponding to the attention target. When an attention target is an expressway attention target point, the control unit 13 causes the virtual image display unit 21 to display not a warning object but the above-described signboard object as a display object corresponding to the attention target.

It should be noted that in the description below, a display object corresponding to an attention target is referred to as “corresponding display object”. In addition, in the description below, as a matter of convenience, a statement that the control unit 13 causes the virtual image display unit 21 to display a corresponding display object may be put in another way as follows: the control unit 13 displays a corresponding display object.

As another control related to displaying by the virtual image display unit 21, the control unit 13 controls at least the virtual image distance from between the virtual image distance and the virtual image direction of the corresponding display object on the basis of the attention information acquired by the information acquisition unit 11. In other words, the control unit 13 controls the virtual image distance of the corresponding display object, or controls both of the virtual image distance and the virtual image direction of the corresponding display object, on the basis of the attention information acquired by the information acquisition unit 11.

Here, the control of the virtual image distance is realized by controlling an optical path length from an indicator that forms the virtual image display unit 21 to the corresponding display object. In addition, the control of the optical path length can be realized, for example, by controlling a position in an optical axis direction of the indicator, or by controlling a mirror in the middle of an optical path.

The control of the virtual image direction is realized, for example, by controlling a position of the corresponding display object in a displayable area of the virtual image display unit 21. It should be noted that the displayable area is an area on the windshield 81, in which the indicator of the virtual image display unit 21 is capable of displaying the corresponding display object.

### Conclusion of First Embodiment

The display control apparatus 1 according to the present first embodiment such as that described above controls at least the virtual image distance, from between the virtual image distance and the virtual image direction of the corresponding display object, on the basis of attention information that includes at least any one of a property of an attention target, a relative position and a relative direction of the attention target. This enables to adequately alert the driver to the attention target.

### Second Embodiment

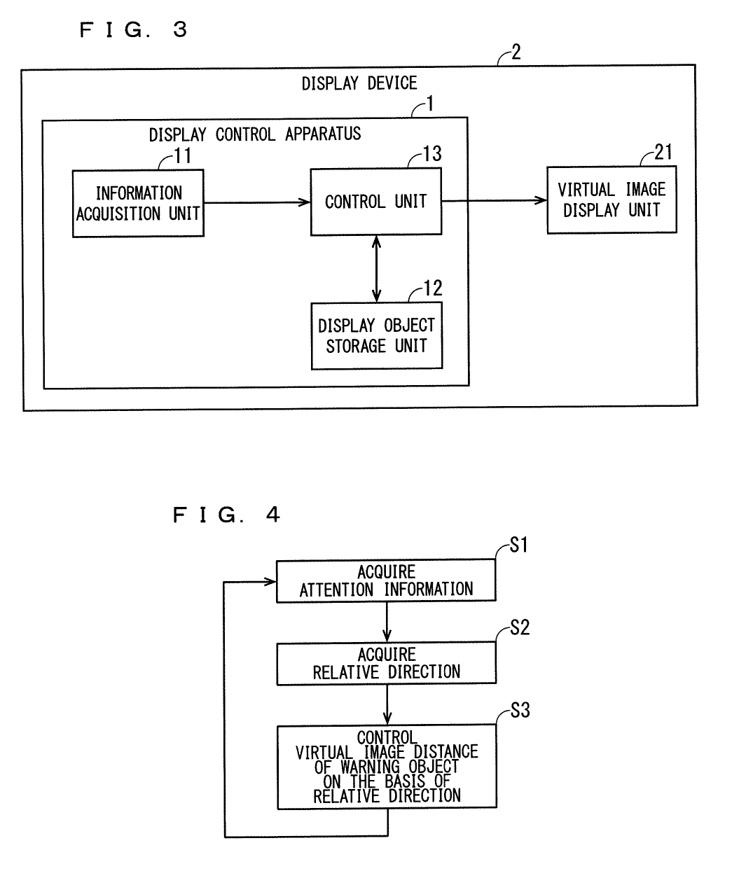

FIG. 3 is a block diagram illustrating a configuration of a display device according to a second embodiment of the present invention. In the description below, the display device 2 according to the present second embodiment uses the same reference numerals to denote components that are the same as, or similar to, those in the first embodiment, and components different therefrom will be mainly described.

The display device 2 shown in FIG. 3 is provided with the display control apparatus 1 and the virtual image display unit 21. The display control apparatus 1 shown in FIG. 3 is provided with components similar to those in the first embodiment (the information acquisition unit 11, the display object storage unit 12, and the control unit 13 in FIG. 1).

In the present second embodiment, attention information includes a relative position or a relative direction of an attention target with respect to the own vehicle, and the attention target is an attention target object (a moving object, a non-moving object). In this case, as described in the first embodiment, the information acquisition unit 11 acquires (generates) attention information that includes a relative position or a relative direction, with respect to the own vehicle, of an attention target object around the own vehicle. In addition, the attention target is an attention target object, and therefore the control unit 13 according to the present second embodiment causes the virtual image display unit 21 to display a warning object as a corresponding display object.

Here, the relative direction corresponds to an angle 8 defined with respect to the forward direction of the own vehicle. On the assumption that when a position of the own vehicle is defined as an original point, a relative position of an attention target object in the lateral direction of the own vehicle is x, and a relative position of the attention target object in the forward direction of the own vehicle is y, the angle 8 indicating the relative direction can be calculated by, for example, tan⁻¹(x/y) (FIG. 2). It should be noted that in the description below, as a matter of convenience, the angle 0 indicating the relative direction may be referred to as “relative direction θ”.

It should be noted that in the present second embodiment, the information acquisition unit 11 acquires the color and hue of the attention target extracted by, for example, the image processing device described in the first embodiment. For example, the information acquisition unit 11 acquires a color, the occupation ratio of which is the highest in the whole attention target (further including a rider in the case of a bicycle, a motorcycle or the like), as the color and hue of the attention target.

FIG. 4 is a flowchart showing the operation of the display device 2 according to the present second embodiment.

First of all, in a step S1, the information acquisition unit 11 acquires attention information.

In a step S2, when the attention information acquired by the information acquisition unit 11 includes a relative direction 0 of an attention target object, the control unit 13 acquires the relative direction θ, and the process proceeds to a step S3. When the attention information acquired by the information acquisition unit 11 includes a relative position of the attention target object, the information acquisition unit 11 calculates (acquires) the relative direction θ of the attention target object by using the above-described formula on the basis of the relative position, and the process proceeds to a step S3.

In the step S3, the control unit 13 controls a virtual image distance of a warning object on the basis of the relative direction 8 acquired by the information acquisition unit 11. In this case, the control unit 13 according to the present second embodiment also controls a virtual image direction of the warning object on the basis of the relative direction θ. At this moment, a direction of the warning object and a direction of the attention target object are not always required to completely agree with each other. When the direction of the warning object slightly deviates from the direction of the attention target object, the warning object and the attention target object do not overlap each other in appearance, and therefore the visibility is enhanced. In addition, the control unit 13 causes the color and hue of the warning object to correspond to the color and hue of the attention target object acquired by the information acquisition unit 11. Subsequently, the process returns to the step S1.

FIG. 5 is a diagram illustrating an example of the control of the virtual image distance in the step S3. It should be noted that an area between an angle θmin and an angle θmax corresponds to a displayable area of the virtual image display unit 21 (an area on the windshield 81 that is capable of displaying a display object).

As shown in FIG. 5, the control unit 13 controls a virtual image distance of a warning object in such a manner that the virtual image distance of the warning object increases with the decrease in angle θ formed by the forward direction of the own vehicle and the relative direction acquired in the step S2 (the relative direction based on the attention information acquired by the information acquisition unit 11). Here, as an example, when the angle θ falls within an area between the angle θmin and an angle θ1 or an area between an angle θ2 and the angle θmax (hereinafter referred to as “obliquely forward area”) shown in FIG. 5, the control unit 13 shortens the virtual image distance of the warning object (for example, 10 m). Meanwhile, when the angle θ falls within an area between the angle θ1 and the angle θ2 (hereinafter referred to as “forward area”) shown in FIG. 5, the control unit 13 lengthens the virtual image distance of the warning object (for example, 50 m). However, a value of the virtual image distance is not limited to 10 m and 50 m. In addition, instead of controlling the virtual image distance in two stages on the basis of the angle θ as shown in FIG. 5, the control unit 13 may control the virtual image distance in three or more stages, or may continuously control the virtual image distance.

It should be noted that FIG. 5 illustrates the warning object in such a manner that the warning object is displayed on a spherical surface (on a circular arc in FIG. 5). In general, a curved surface lens is used on the output side of the HUD to make a displaying correction so as to display the warning object on a plane (on a chain double-dashed line in FIG. 5). It should be noted that when the virtual image distance ri is large, the above-described spherical surface (the circular arc in FIG. 5) can be approximated to the above-described plane (the chain double-dashed line in FIG. 5).

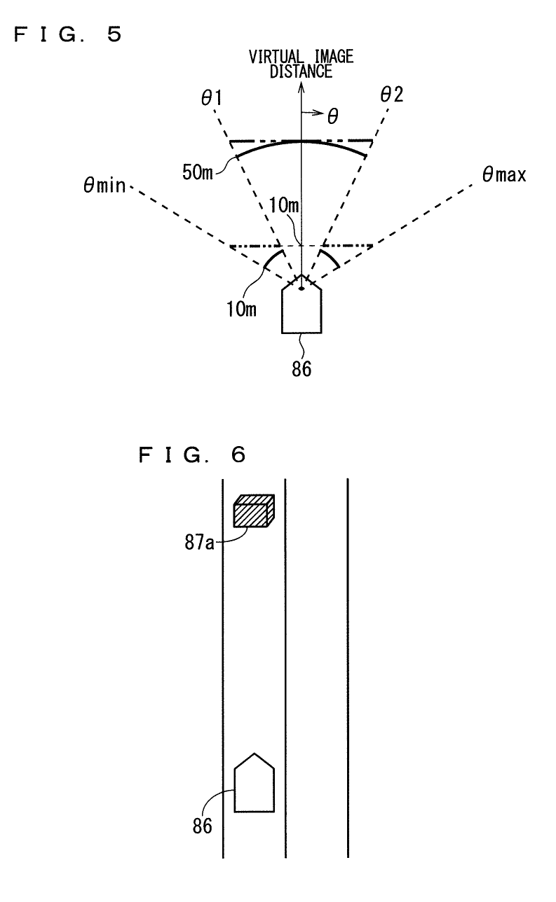

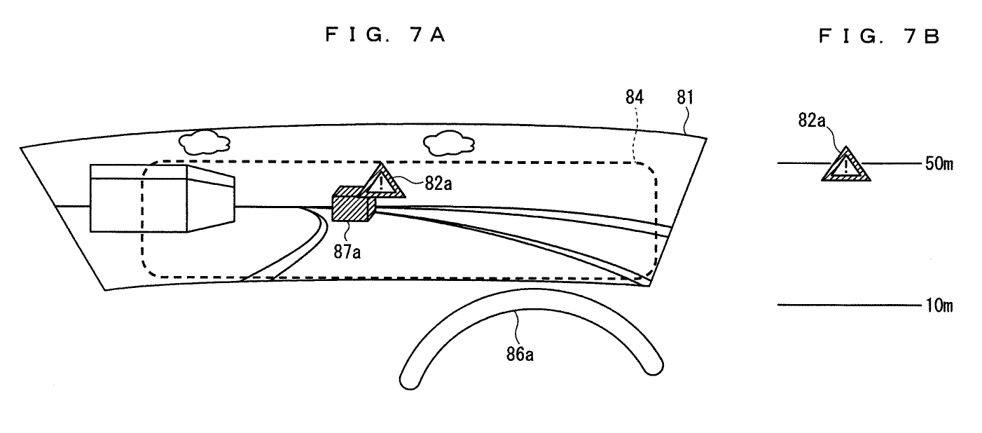

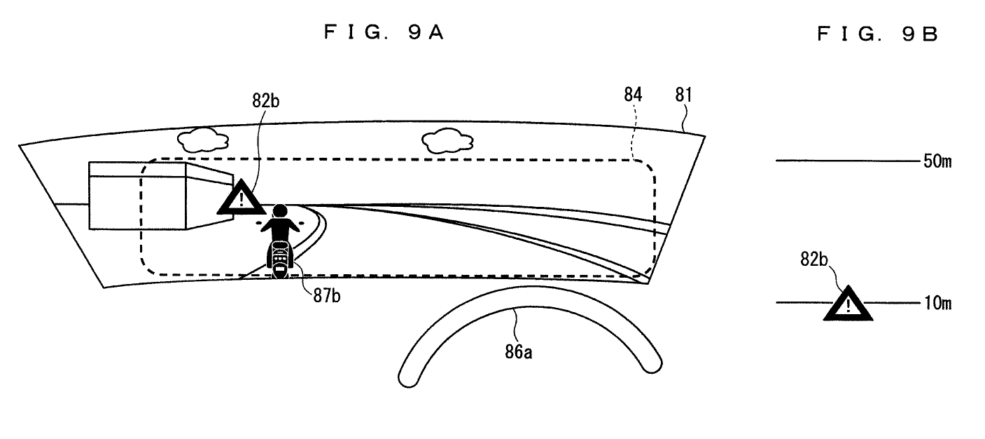

FIGS. 6 to 9 are drawings each illustrating displaying by the display device 2 according to the present second embodiment. Incidentally, FIGS. 7 and 9 each show a handle 86a of the own vehicle, and a displayable area 84 of the virtual image display unit 21. It should be noted that although a right handle (left-hand traffic) configuration is described below as an example, the same applies to a left handle (right-hand traffic) configuration.

FIG. 6 shows a state in which a falling object 87a that is a non-moving object exists in a forward area. FIGS. 7A and 7B show examples of displaying by the display device 2 in the state shown in FIG. 6. As shown in FIG. 6, when the falling object 87a exists in the forward area, the control unit 13 controls a virtual image distance of a warning object 82a of the falling object 87a to be 50 m as shown in FIG. 7A and FIG. 7B. In this case, as shown in FIG. 7A, the control unit 13 displays the warning object 82a in proximity to the falling object 87a viewing from the driver seat. For example, the control unit 13 controls the virtual image direction of the warning object 82a in such a manner that an angle formed by a direction of the falling object 87a viewing from the driver seat and a virtual image direction of the warning object 82a becomes a threshold value or less. In addition, the control unit 13 causes a color of the edge part of the warning object 82a to correspond to the color of the falling object 87a acquired by the information acquisition unit 11 (in FIGS. 7A and 7B, a color corresponding to oblique line hatching).

In this case, it is preferable that the warning object 82a be displayed by aligning, not only the virtual image distance, but also the virtual image direction with a direction of the falling object 87a. In addition, displaying the warning object 82a in the same direction as that of the falling object 87a may make it difficult to identify the warning object 82a and the falling object 87a. Accordingly, the warning object 82a may be displayed in a direction slightly above the falling object 87a, or in a direction of blank scenery.

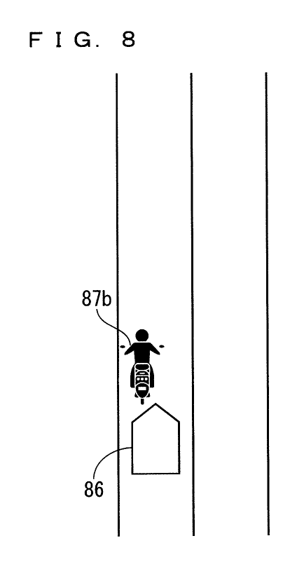

FIG. 8 shows a state in which a motorcycle 87b that is a moving object exists not in the forward area but in the obliquely forward area. FIGS. 9A and 9B show examples of displaying by the display device 2 in the state shown in FIG. 8. As shown in FIG. 8, when the motorcycle 87b exists in the obliquely forward area, the control unit 13 controls the virtual image distance of the warning object 82b of the motorcycle 87b (in FIG. 9A) to be 10 m as shown in FIG. 9A and FIG. 9B. In this case, as shown in FIG. 9A, the control unit 13 displays the warning object 82b in proximity to the motorcycle 87b viewing from the driver seat. In addition, the control unit 13 causes a color of the edge part of the warning object 82b to correspond to the color of the motorcycle 87b acquired by the information acquisition unit 11 (in FIGS. 9A and 9B, a color corresponding to black hatching).

### Conclusion of Second Embodiment

In general, when a driver who is currently driving views a forward area, a focus of the driver tends to become far, and when the driver views an obliquely forward area, the focus of the driver tends to become near. In addition, an attention target object that exists in the obliquely forward area generally exists near the own vehicle. Taking the above into consideration, the display device 2 according to the present second embodiment increases the virtual image distance of the warning object with the decrease in angle θ formed by the forward direction of the own vehicle and the relative direction based on the attention information acquired by the information acquisition unit 11. This enables to adequately alert the driver to the attention target.

In addition, in the explanation that uses FIGS. 7A and 7B, the virtual image distance of the attention target object that exists on a left turning road is determined within the range defined by the angles θ1, θ2, θmin, θmax. However, the present invention is not limited to this. The virtual image distance may be controlled, for example, by subjecting the left turning road to a mapping process as a straight road extending forward to correct a direction of the attention target object, and then by apply the control shown in FIG. 5 to the corrected direction. In this case, the warning object is displayed at the center of the road along which the own vehicle is traveling, and therefore a warning that is natural to the senses of the driver can be presented.

In addition, the display device 2 according to the present second embodiment causes the color and hue of the warning object to correspond to the color and hue of the attention target object acquired by the information acquisition unit 11. This enables the driver to easily recognize the correspondence relationship between the attention target object and the warning object.

### FIRST MODIFIED EXAMPLE

In the second embodiment, the warning object is displayed for the attention target object that exists in the displayable area of the virtual image display unit 21. Meanwhile, the display device 2 according to the first modified example is also capable of displaying a warning object for an attention target object that exists outside the displayable area of the virtual image display unit 21.

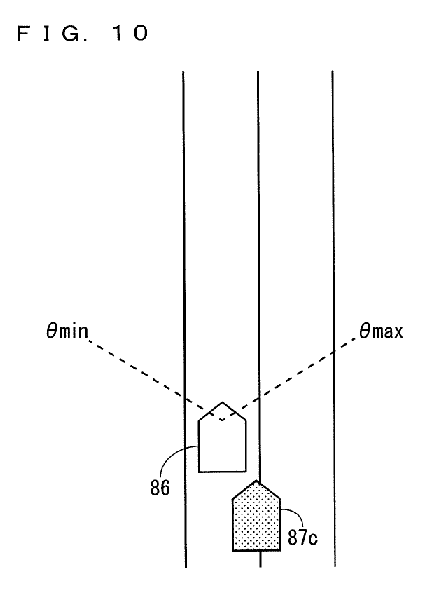

FIG. 10, FIGS. 11A and 11B are drawings each illustrating displaying by the display device 2 according to the first modified example.

FIG. 10 shows a state in which an other vehicle 87c that is a moving object exists outside the displayable area (corresponding to the area between the angle θmin and the angle θmax in FIG. 5). FIGS. 11A and 11B show examples of displaying by the display device 2 in the state shown in FIG. 10. As shown in FIG. 10, when the other vehicle 87c exists outside the displayable area, the control unit 13 cannot display a warning object of the other vehicle 87c in proximity to the other vehicle 87c viewing from the driver seat. Accordingly, first of all, the control unit 13 according to the first modified example determines whether or not the relative direction θ of the attention target object based on the attention information acquired by the information acquisition unit 11 exists between the angle θmin and the angle θmax. When the relative direction θ exists between the angle θmin and the angle θmax shown in FIG. 5, the control unit 13 determines that a position of the attention target object exists in the displayable area of the virtual image display unit 21. Meanwhile, when the relative direction θ does not exist between the angle θmin and the angle θmax, the control unit 13 determines that a position of the attention target object exists outside the displayable area of the virtual image display unit 21.

When the control unit 13 determines that the position of the attention target object exists in the displayable area of the virtual image display unit 21, the control unit 13 performs displaying in a manner similar to that of the second embodiment.

Meanwhile, when the control unit 13 determines that the position of the attention target object exists outside the displayable area of the virtual image display unit 21, the control unit 13 controls the virtual image display unit 21 in such a manner that the warning object of the attention target object is displayed in the end part of the displayable area. Here, as an example thereof, when a value of the angle θ is closer to a value of the angle θmin than a value of the angle θmax, the control unit 13 displays the warning object of the attention target object in the left end part of the displayable area. When the value of the angle θ is closer to the value of the angle θmax than the value of the angle θmin, the control unit 13 displays the warning object of the attention target object in the right end part of the displayable area.

FIGS. 11A and 11B show examples of displaying by the display device 2 according to the first modified example in the state of FIG. 10. In the state of FIG. 10, the relative direction θ of the other vehicle 87c is closer to the angle θmax than the angle θmin shown in FIG. 5, and therefore, as shown in FIG. 11A, the control unit 13 displays the warning object 82c of the other vehicle 87c in the right end part of the displayable area 84. In this case, as shown in FIG. 11A and FIG. 11B, the control unit 13 controls the virtual image distance of the warning object 82c of the other vehicle 87c to be, for example, 10 m. However, a value of the virtual image distance is not limited to 10 m. In addition, the control unit 13 may control the virtual image distance on the basis of the angle θ in a plurality of stages or may continuously control the virtual image distance.

The control unit 13 causes a color of the edge part of the warning object 82c to correspond to the color of the other vehicle 87c acquired by the information acquisition unit 11 (in FIGS. 11A and 11B, a color corresponding to sand hatching). It should be noted that when a warning object of an attention target object outside the displayable area 84 is displayed, as shown in FIG. 11A, the control unit 13 may display a mark of “Pay attention to rearward” or “Pay attention to right rearward”, for example, in the central lower part of the displayable area 84.

When it is determined that a position of an attention target object is outside the displayable area 84 of the virtual image display unit 21, the display device 2 according to the first modified example such as that described above displays the warning object of the attention target object in the end part of the displayable area 84. This enables to adequately alert a driver to an attention target object that is located sideward or rearward (for example, another vehicle that intends to pass the own vehicle).

In addition, controlling an elevation angle of the warning object to be aligned with a direction of the attention target object enables to enhance the recognizability. It should be noted that a driver often looks at a distant place during traveling, and a sight line at the time of looking at a distant place is slightly higher than a sight line at the time of looking at a near place. Accordingly, displaying the warning object of the attention target object, which is close to the own vehicle, with the elevation angle thereof set slightly on the upper side enables to further enhance the recognizability. In addition, a driver tends to look at a more distant place with the increase in speed of the own vehicle. Therefore, the control unit 13 may change the elevation angle of the warning object according to the speed; for example, the warning object is moved to the further upper side with the increase in speed of the own vehicle.

### SECOND MODIFIED EXAMPLE

In the present second embodiment, one warning object is displayed on the assumption that one attention target object exists. However, the present invention is not limited to this. When a plurality of attention target objects exist, a plurality of warning objects may be displayed.

More specifically, in the second modified example, the information acquisition unit 11 acquires attention information about each of a plurality of attention target objects. In addition, the control unit 13 is configured to be capable of individually controlling a virtual image distance of each warning object of each attention target object on the basis of the attention information about the plurality of attention target objects acquired by the information acquisition unit 11.

It should be noted that as a configuration in which a virtual image distance of each warning object (each corresponding display object) is individually controlled, in other words, as a configuration in which virtual image distances may differ from each other, it is possible to conceive of a configuration in which the virtual image display unit 21 is composed of a plurality of indicators, and a position of an optical axis direction of each indicator is individually controlled. However, the present invention is not limited to this. A configuration in which each mirror in the middle of an optical path is individually controlled may be used. A reduction in the number of indicators that compose the virtual image display unit 21 can be expected by the configuration in which each mirror is individually controlled. It should be noted that when the virtual image display unit 21 is not capable of individually controlling the virtual image distance of each warning object, those virtual image distances may be uniformly controlled.

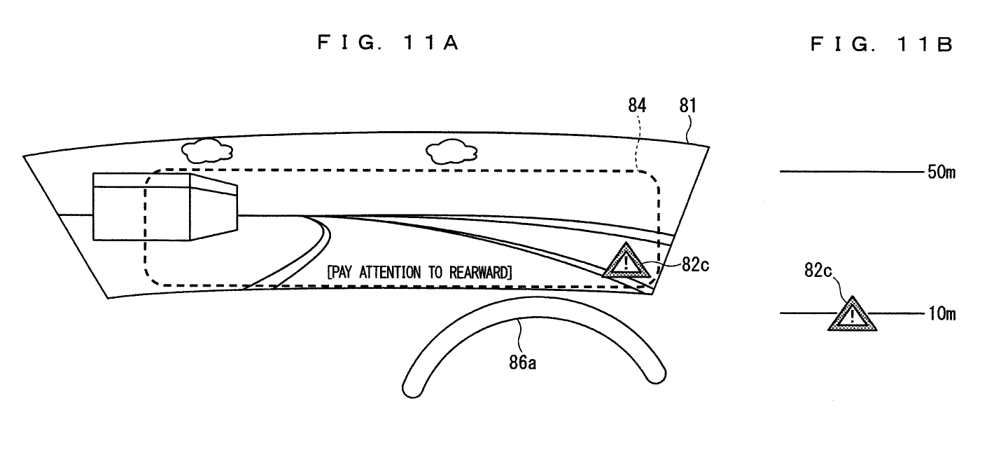

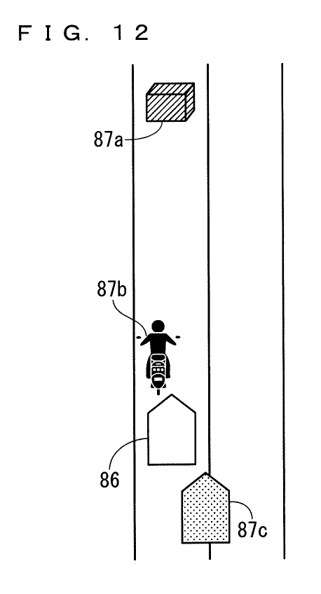

FIG. 12, FIGS. 13A and 13B are drawings each illustrating displaying by the display device 2 according to the second modified example. FIG. 12 illustrates a combination of states shown in FIGS. 6, 8 and 10. In the case of the state of FIG. 12, as shown in FIG. 13A, the control unit 13 displays the warning objects 82a, 82b, 82c shown in FIGS. 7A, 7B, 9A, 9B, 11A and 11B in combination. Incidentally, as shown in FIG. 13B, as with the second embodiment and the first modified example, in the second modified example as well, the virtual image distance of the warning object 82a is 50 m, and the virtual image distances of the warning object 82b, 82c are 10 m.

The display device 2 according to the second modified example such as that described above individually controls a virtual image distance of each warning object of each attention target object. This enables the driver to visually recognize each warning object at a proper virtual image distance.

### THIRD MODIFIED EXAMPLE

The present second embodiment has been described on the assumption that the attention target is the attention target object (the moving object and the non-moving object). However, the present invention is not limited to this. The attention target may be an attention target point such as the accident-prone point described in the first embodiment.

For example, as described in the first embodiment, the information acquisition unit 11 acquires (generates) attention information that includes a relative position or a relative direction, with respect to the own vehicle, of an attention target point around the own vehicle among a plurality of attention target points set beforehand as points to which a driver should be alerted. Subsequently, the operation in which the attention target object is replaced with the attention target point is performed in the steps S2 and S3 (in FIG. 4) described in the second embodiment in a similar manner.

As with the above-described attention target object, the attention target point can be applied, as an attention target, to the display device 2 according to the third modified example such as that described above. Therefore, a driver can also be adequately alerted to an accident-prone point or the like in a manner similar to that of the second embodiment.

It should be noted that the first to third modified examples described above may be applied as appropriate in third and subsequent embodiments described below.

### Third Embodiment

A block diagram of a display device according to a third embodiment of the present invention is similar to the block diagram (FIG. 3) of the display device according to the second embodiment. In the description below, the display device 2 according to the present third embodiment uses the same reference numerals to denote components that are the same as, or similar to, those in the second embodiment, and components different therefrom will be mainly described. It should be noted that the information acquisition unit 11, the display object storage unit 12, and the control unit 13 according to the present third embodiment may have, or do not have to have, the same functions as those of the second embodiment.

In the present third embodiment, it is assumed that attention information includes, as a property of an attention target, an attention degree indicating a degree to which a driver should be alerted to the attention target around the own vehicle. In this case, as described in the first embodiment, the information acquisition unit 11 acquires (generates) attention information that includes the attention degree. In addition, in the present third embodiment, the attention target is, for example, a person, a motorbike, an other vehicle, and a non-moving object. In this case, the control unit 13 according to the present third embodiment causes the virtual image display unit 21 to display a warning object as a corresponding display object.

Moreover, in the present third embodiment, it is assumed that a degree of attention to a person, a degree of attention to a motorbike or an other vehicle, a degree of attention to a non-moving object decrease in this order. In other words, it is assumed that a degree of attention to an attention target increases with the increase in influence exerted on a human body when a vehicle hits the attention target. It should be noted that a human body of a person riding in a vehicle, a human body of a person that is an attention target, a human body of a person riding on a motorbike, and the like apply to the human body described here.

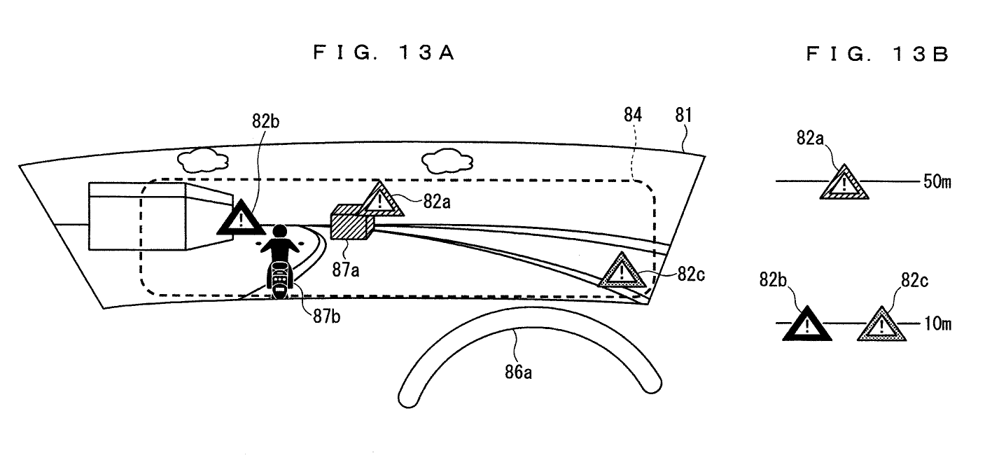

FIGS. 14A and 14B are drawings illustrating displaying by the display device 2 according to the present third embodiment. The control unit 13 according to the third embodiment changes a shape of a warning display object on the basis of a property of an attention target (the attention degree included in the attention information acquired by the information acquisition unit 11). More specifically, as shown in FIG. 14A, when the attention target is a person 87e (when the attention degree is high), the control unit 13 displays a warning object 82e that surrounds the person 87e viewing from the driver seat. When the attention target is a falling object (a non-moving object) 87f (when the attention degree is low), the control unit 13 displays a warning object 82f in proximity to the falling object 87f viewing from the driver seat.

In addition, as shown in FIG. 14B, the control unit 13 according to the third embodiment controls a virtual image distance of the warning object on the basis of the property of the attention target (the attention degree included in the attention information acquired by the information acquisition unit 11). Here, as an example, the control unit 13 controls the virtual image distance in such a manner that the virtual image distance is shortened with the increase in attention degree. In the example of FIG. 14B, in the case of the person 87e, the attention degree of which is high, the control unit 13 shortens the virtual image distance of the warning object 82e of the person 87e (for example, 10 m). Meanwhile, in the case of the falling object 87f, the attention degree of which is low, the control unit 13 lengthens the virtual image distance of the warning object 82f of the falling object 87f (for example, 50 m). In other words, the control unit 13 makes the virtual image distance of the warning object 82f of the falling object 87f longer than the virtual image distance of the warning object 82e of the person 87e.

### Conclusion of Third Embodiment

In the display device 2 according to the third embodiment such as that described above, the virtual image distance of the warning object is controlled on the basis of the attention degree included in the attention information. In general, a warning object having a short virtual image distance is capable of attracting more attention of a driver, and therefore the driver can be properly alerted to the warning object.

### Fourth Embodiment

A block diagram of a display device according to a fourth embodiment of the present invention is similar to the block diagram (FIG. 3) of the display device according to the second embodiment. In the description below, the display device 2 according to the present fourth embodiment uses the same reference numerals to denote components that are the same as, or similar to, those in the second embodiment, and components different therefrom will be mainly described. It should be noted that the information acquisition unit 11, the display object storage unit 12, and the control unit 13 according to the present fourth embodiment have the same functions as those of the third embodiment.

The information acquisition unit 11 acquires, as a traveling direction of the own vehicle, a direction that is indicated by a direction indicator provided on the own vehicle. Alternatively, the information acquisition unit 11 acquires a traveling direction of the own vehicle detected by a sensor provided on the own vehicle. Alternatively, the information acquisition unit 11 acquires, as a traveling direction of the own vehicle, a traveling direction, the frequency of which is the highest at an intersection, from a traveling history of the intersection, the traveling history being stored in a storage unit provided on the own vehicle. It should be noted that although the information acquisition unit 11 has been described here as a unit provided separately from the direction indicator, the sensor or the storage unit described above, the present invention is not limited to this, and thus the information acquisition unit 11 may include the direction indicator, the sensor or the storage unit described above. In addition, the traveling direction of the own vehicle will be described below as a future traveling direction of the own vehicle. However, the traveling direction of the own vehicle may be a current traveling direction of the own vehicle.

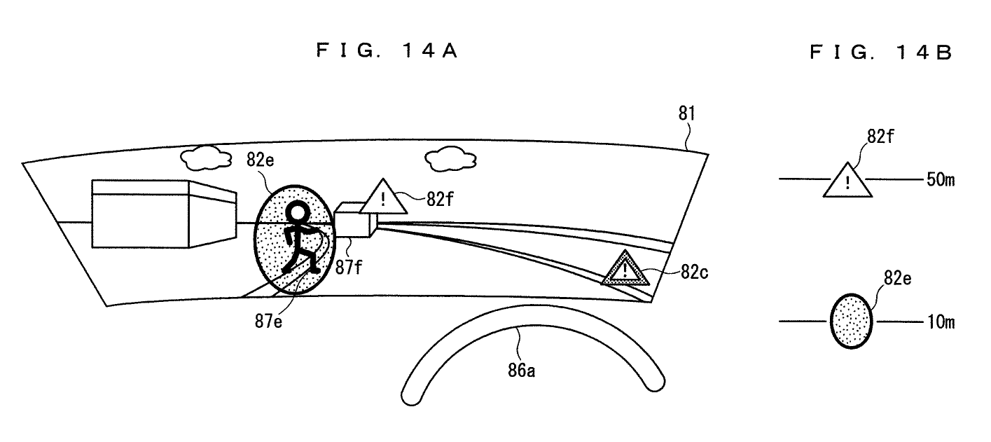

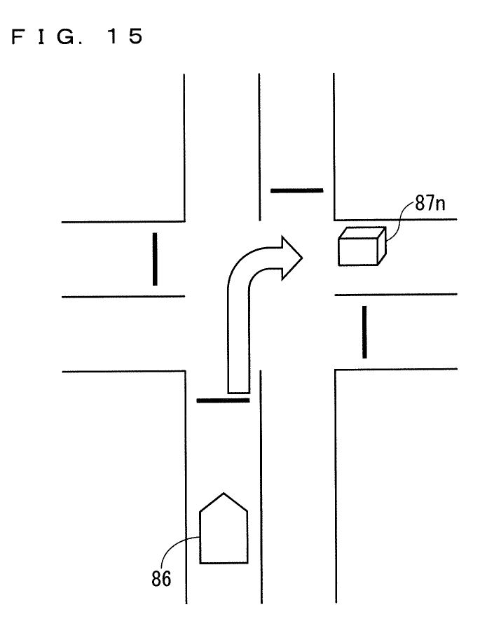

When it is determined, on the basis of the traveling direction acquired by the information acquisition unit 11, that the own vehicle turns right or left, the control unit 13 according to the fourth embodiment controls a virtual image distance on the basis of an attention degree in a manner similar to that of the third embodiment. For example, as shown in FIG. 15, when right turning of the own vehicle 86 is acquired as a traveling direction of the own vehicle, the control unit 13 controls a virtual image distance of a warning object of a falling object 87n on the basis of an attention degree of the falling object (non-moving object) 87n (for example, lengthens the virtual image distance).

### Conclusion of Fourth Embodiment

In the display device 2 according to the fourth embodiment such as that described above, when it is determined that the own vehicle turns right or left, the virtual image distance of the warning object is controlled on the basis of the attention degree. This enables to adequately alert a driver to an attention target when turning right or left.

### Fifth Embodiment

A block diagram of a display device according to a fifth embodiment of the present invention is similar to the block diagram (FIG. 3) of the display device according to the second embodiment. In the description below, the display device 2 according to the present fifth embodiment uses the same reference numerals to denote components that are the same as, or similar to, those in the second embodiment, and components different therefrom will be mainly described. It should be noted that the information acquisition unit 11, the display object storage unit 12, and the control unit 13 according to the present fifth embodiment may have, or do not have to have, the same functions as those of the second embodiment.

In the present fifth embodiment, as with the second embodiment, attention information includes a relative position or a relative direction of an attention target with respect to the own vehicle, and the attention target is an attention target object (a moving object, a non-moving object). In this case, the control unit 13 according to the present fifth embodiment causes the virtual image display unit 21 to display a warning object as a corresponding display object in a manner similar to that of the second embodiment.

In addition, in the present fifth embodiment, as with the fourth embodiment, the information acquisition unit 11 acquires a traveling direction.

In addition, on the basis of the attention information and the traveling direction acquired by the information acquisition unit 11, the control unit 13 according to the fifth embodiment determines whether or not an attention target object influences traveling of the own vehicle. For example, when the attention information acquired by the information acquisition unit 11 includes, as a relative direction or a relative position of the attention target object, information indicating that the attention target object is located forward on the right side of the own vehicle, and when a traveling direction acquired by the information acquisition unit 11 is right turning, the control unit 13 determines that the attention target object influences traveling of the own vehicle.

It should be noted that when the information acquisition unit 11 is configured to be capable of acquiring a moving direction and a moving speed of an attention target object from, for example, a DSRC unit, the control unit 13 may determine, on the basis of the relative direction or the relative position of the attention target object, the moving direction, the moving speed and the traveling direction acquired by the information acquisition unit 11, whether or not the attention target object will influence traveling of the own vehicle in future. It should be noted that using the DSRC unit enables to acquire, for example, the relative direction or the relative position of the attention target object even when the attention target object cannot be seen from the own vehicle.

The control unit 13 makes a virtual image distance of a warning object of an attention target object that has been determined to influence traveling of the own vehicle shorter than a virtual image distance of a warning object of an attention target object that has not been determined to influence traveling of the own vehicle.

FIGS. 16A and 16B are drawings illustrating displaying by the display device 2 according to the present fifth embodiment. It should be noted that although persons ride on respective bicycles 87k, 87l, illustration of the persons is omitted as a matter of convenience in FIG. 16A. It should be noted that although a falling object (non-moving object) 87j can be visually recognized from the own vehicle 86, the bicycle (moving object) 87k cannot be visually recognized from the own vehicle 86.

For example, in a state of FIG. 16A, it is assumed that the information acquisition unit 11 acquires right turning of the own vehicle 86 as a traveling direction of the own vehicle. In this case, it is determined that the falling object (non-moving object) 87j that exists in the traveling direction of the own vehicle, and the bicycle (moving object) 87k that will exist in the traveling direction, will influence traveling of the own vehicle 86. Meanwhile, it is not determined that the bicycle (non-moving object) 87l will influence traveling of the own vehicle 86.

As the result, as shown in FIG. 16B, the control unit 13 shortens virtual image distances of the warning objects 82j, 82k of the falling object 87j and the bicycle 87k respectively (for example, 10 m). Meanwhile, the control unit 13 lengthens a virtual image distance of the warning object 82l of the bicycle 87l (for example, 50 m). In other words, the control unit 13 makes the virtual image distance of the warning object 82l longer than the virtual image distances of the warning objects 82j, 82k.

### Conclusion of Fifth Embodiment

In the display device 2 according to the fifth embodiment such as that described above, the virtual image distance of the warning object of the attention target object that has been determined to influence traveling of the own vehicle is made shorter than the virtual image distance of the warning object of the attention target object that has not been determined to influence traveling of the own vehicle. This enables to adequately alert a driver to the attention target object that influences traveling of the own vehicle.

### Sixth Embodiment

A block diagram of a display device according to a sixth embodiment of the present invention is similar to the block diagram (FIG. 3) of the display device according to the second embodiment. In the description below, the display device 2 according to the present sixth embodiment uses the same reference numerals to denote components that are the same as, or similar to, those in the second embodiment, and components different therefrom will be mainly described. It should be noted that the information acquisition unit 11, the display object storage unit 12, and the control unit 13 according to the present sixth embodiment may have, or do not have to have, the same functions as those of the second embodiment.

In the present sixth embodiment, as with the second embodiment, attention information includes a relative position or a relative direction of an attention target with respect to the own vehicle, and the attention target is an attention target object (a moving object, a non-moving object). In this case, the control unit 13 according to the present sixth embodiment causes the virtual image display unit 21 to display a warning object as a corresponding display object in a manner similar to that of the second embodiment.

In addition, in the present sixth embodiment, as with the fourth embodiment, the information acquisition unit 11 acquires a traveling direction of the own vehicle. Moreover, the information acquisition unit 11 further acquires, for example, from a position detector or the like, a current position of the own vehicle, and from a storage unit or the like, map information in which specific road points including an intersection and a pedestrian crossing are set.

In addition, the control unit 13 according to the sixth embodiment determines, on the basis of the attention information, the traveling direction, the current position and the map information acquired by the information acquisition unit 11, whether or not an attention target object exists in proximity to a specific road point through which the own vehicle travels.

For example, the control unit 13 determines, on the basis of the traveling direction, the current position and the map information acquired by the information acquisition unit 11, whether or not the own vehicle travels through a specific road point. In addition, when it is determined that the own vehicle travels through the specific road point, the control unit 13 determines, on the basis of a position of the specific road point, and the relative position or the relative direction of the attention target object included in the attention information acquired by the information acquisition unit 11, whether or not the attention target object exists in proximity to the specific road point (for example, within 5 m from the position of the specific road point).

Subsequently, the control unit 13 makes a virtual image distance of a warning object of an attention target object that has been determined to exist in proximity to the specific road point through which the own vehicle travels shorter than a virtual image distance of a corresponding display object of an attention target object that has not been determined to exist in proximity to the specific road point.

For example, in a state of FIG. 17A, the control unit 13 determines that the falling object (non-moving object) 87n does not exist in proximity to a specific road point. Therefore, as shown in FIG. 17B, the control unit 13 lengthens a virtual image distance of a warning object 82n of the falling object 87n (for example, 50 m).

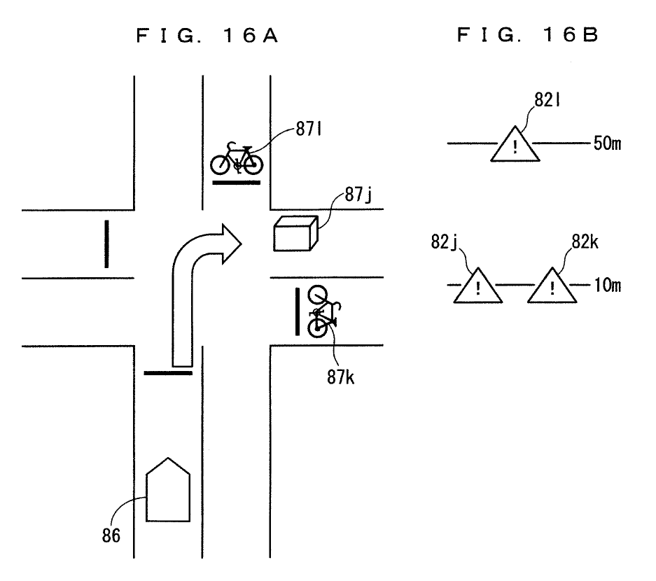

For example, in a state of FIG. 18A, the control unit 13 determines that the falling object (non-moving object) 87n exists in proximity to a pedestrian crossing (specific road point). Therefore, as shown in FIG. 18B, the control unit 13 shortens the virtual image distance of the warning object 82n of the falling object 87n (for example, 10 m). In other words, the control unit 13 makes the virtual image distance of the warning object 82n shown in FIG. 18B shorter than the virtual image distance of the warning object 82n shown in FIG. 17B.

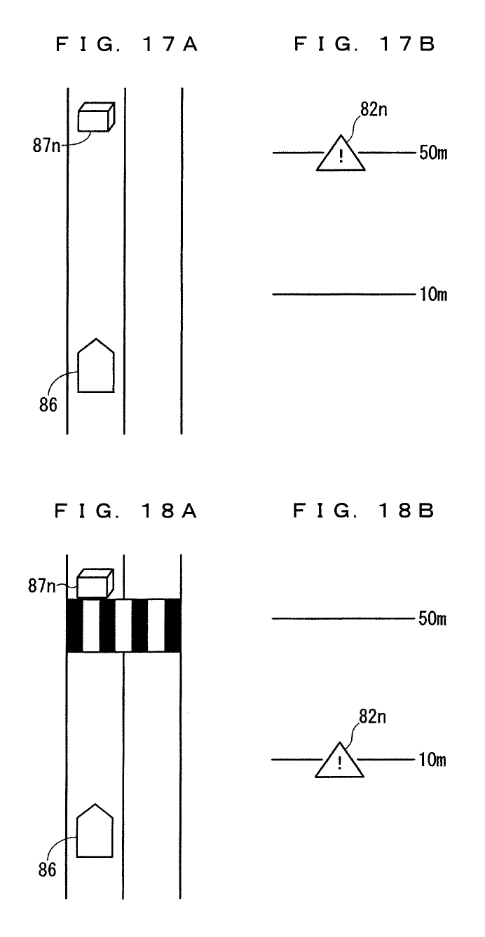

In addition, there is a case where whether the own vehicle will go straight ahead or turn right or left is not recognized on the vehicle side (the control unit 13). In this case, an attention target object is checked in all directions. For example, in a state of FIG. 19A, the control unit 13 determines that a falling object (non-moving object) 87o located outside a circle area indicated with a broken line does not exist in proximity to an intersection (specific road point), and determines that falling objects (non-moving objects) 87p, 87q located in the circle area indicated with the broken line exist in proximity to the intersection (specific road point). As the result, as shown in FIG. 19B, the control unit 13 lengthens a virtual image distance of a warning object 82o of the falling object 87o (for example, 50 m), and shortens virtual image distances of warning objects 82p, 82q of the falling objects 87p, 87q respectively (for example, 10 m).

### Conclusion of Sixth Embodiment

In the display device 2 according to the sixth embodiment such as that described above, a virtual image distance of a warning object of an attention target object that has been determined to exist in proximity to a specific road point is made shorter than a virtual image distance of a corresponding display object of an attention target object that has not been determined to exist in proximity to the specific road point. This enables to adequately alert a driver to the attention target object in proximity to the specific road point.

### FOURTH MODIFIED EXAMPLE

Here, when the control unit 13 recognizes that the own vehicle will turn right, the control unit 13 may perform the control in the fifth embodiment and the control in the sixth embodiment in combination. For example, in the state of FIG. 19A, from between the falling objects 87p, 87q located in the circle area indicated with the broken line, the control unit 13 may make a virtual image distance of the falling object 87q that influences traveling of the own vehicle 86 shorter than a virtual image distance of the falling object 87p that does not influence traveling of the own vehicle 86. Incidentally, as a method for making the virtual image distance of the falling object 87q shorter than the virtual image distance of the falling object 87p, it is assumed that the virtual image distance of the falling object 87q is shortened, or the virtual image distance of the falling object 87p is lengthened, or both of them are performed.

In addition, in the sixth embodiment, the control of the above-described virtual image distance may be started when it is determined that the own vehicle is traveling through the specific road point. For example, the control unit 13 determines, on the basis of the current position of the own vehicle and the map information acquired by the information acquisition unit 11, whether or not a distance between the current position of the own vehicle and the specific road point has become a threshold value (for example, 20 m) or less. When it is determined that the distance has become the threshold value or less, the control unit 13 determines that the own vehicle is traveling through the specific road point. In addition, the control unit 13 may make a virtual image distance of a warning object of an attention target object that has been determined to exist in proximity to the specific road point through which the own vehicle is traveling shorter than a virtual image distance of a corresponding display object of an attention target object that has not been determined to exist in proximity to the specific road point.

In addition, as another example, when the information acquisition unit 11 is capable of acquiring a traveling speed of the own vehicle from an ECU (Electronic Control Unit) or the like of the own vehicle, the control unit 13 determines, on the basis of the traveling speed, the current position of the own vehicle and the map information, whether or not the time until the current position of the own vehicle arrives at a specific road point has become a threshold value (for example, 5 sec.) or less. When it is determined that the time has become the threshold value or less, the control unit 13 determines that the own vehicle is traveling through the specific road point. In addition, the control unit 13 may make a virtual image distance of a warning object of an attention target object that has been determined to exist in proximity to the specific road point through which the own vehicle is traveling shorter than a virtual image distance of a corresponding display object of an attention target object that has not been determined to exist in proximity to the specific road point.

### Seventh Embodiment

A block diagram of a display device according to a seventh embodiment of the present invention is similar to the block diagram (FIG. 3) of the display device according to the second embodiment. In the description below, the display device 2 according to the present seventh embodiment uses the same reference numerals to denote components that are the same as, or similar to, those in the second embodiment, and components different therefrom will be mainly described. It should be noted that the information acquisition unit 11, the display object storage unit 12, and the control unit 13 according to the present seventh embodiment may have, or do not have to have, the same functions as those of the second embodiment.

In the present seventh embodiment, attention information includes a relative position of an attention target with respect to the own vehicle, and the attention target is an attention target object (a moving object, a non-moving object). In this case, as described in the first embodiment, the information acquisition unit 11 acquires (generates) attention information that includes a relative position, with respect to the own vehicle, of an attention target object around the own vehicle. In addition, the attention target is an attention target object, and therefore the control unit 13 according to the present seventh embodiment causes the virtual image display unit 21 to display a warning object as a corresponding display object. However, the warning object according to the present seventh embodiment includes a symbol warning object that indicates a warning by using a symbol such as a mark, and a character warning object that indicates a warning by using characters.

On the basis of the relative position included in the attention information acquired by the information acquisition unit 11, the control unit 13 according to the seventh embodiment calculates a distance between the own vehicle and the attention target object. In addition, on the basis of the distance that has been calculated (hereinafter referred to as “calculated distance”), the control unit 13 individually controls at least any one of a display size and a virtual image distance of a symbol warning object of the attention target object, and the at least any one of a character warning object of the attention target object.

In other words, on the basis of the calculated distance, the control unit 13 individually controls the display size of the symbol warning object and the display size of the character warning object, individually controls the virtual image distance of the symbol warning object and the virtual image distance of the character warning object, or individually controls the display size and the virtual image distance of the symbol warning object and the display size and the virtual image distance of the character warning object.

In the present seventh embodiment, as an example of the above, the control unit 13 individually controls the display size of the symbol warning object, and the display size of the character warning object. More specifically, the control unit 13 performs the above-described control in such a manner that a degree to which the display size of the character warning object decreases with the increase in calculated distance becomes smaller than a degree to which the display size of the symbol warning object decreases with the increase in calculated distance.

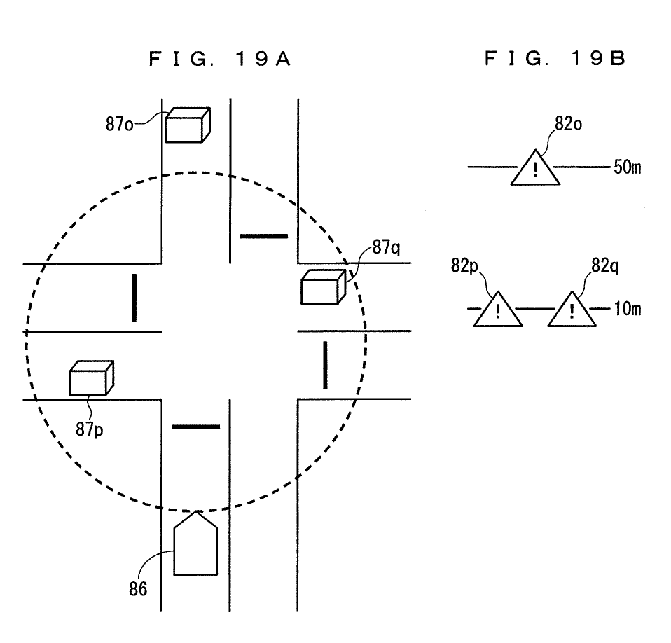

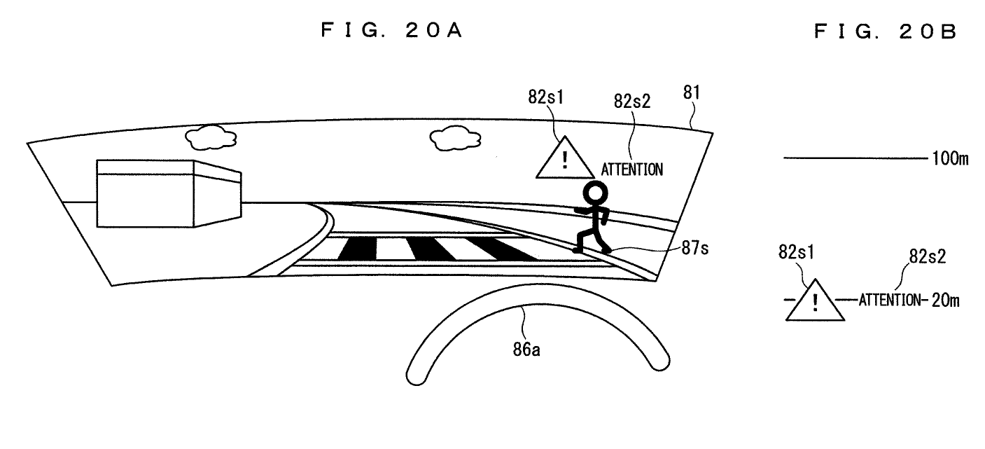

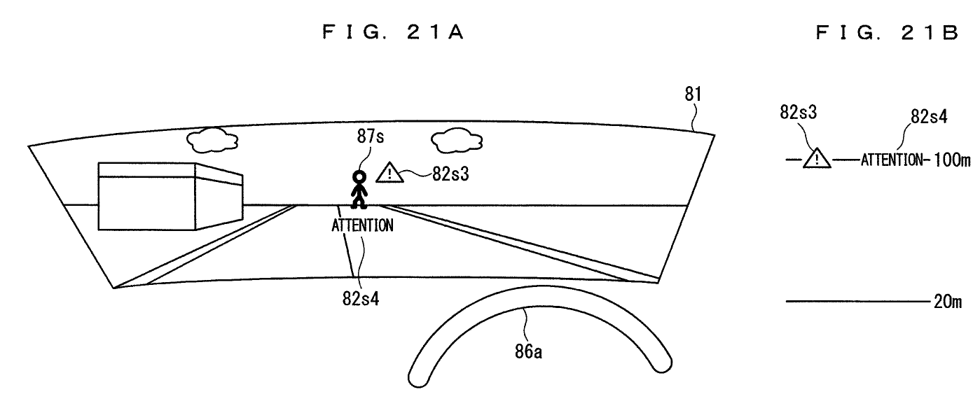

FIGS. 20A and 20B are drawings illustrating an example of displaying by the display device 2 according to the present seventh embodiment in a case where a distance between the own vehicle and a person 87s is 20 m. Meanwhile, FIGS. 21A and 21B are drawings illustrating an example of displaying by the display device 2 according to the present seventh embodiment in a case where a distance between the own vehicle and the person 87s is 100 m.

In the cases of FIG. 20A and FIG. 20B, the above-described calculated distance is short, and therefore the control unit 13 displays, as a warning object of the person 87s, a symbol warning object 82s1, the display size of which is large, and displays a character warning object 82s2, the display size of which is large.

Meanwhile, in the cases of FIG. 21A and FIG. 21B, the above-described calculated distance is long, and therefore the control unit 13 displays, as a warning object of the person 87s, a symbol warning object 82s3, the display size of which is small, and a character warning object 82s4. However, in this case, the control unit 13 displays not the character warning object, the display size of which is small, but the character warning object 82s4, the display size of which is large (for example, the character warning object 82s4, the display size of which is the same as that of the character warning object 82s2).

As described above, in the present seventh embodiment, the degree to which a reduction is made from the character warning object 82s2 to the character warning object 82s4 is smaller than the degree to which a reduction is made from the symbol warning object 82s1 to the symbol warning object 82s3.

Next, the virtual image distance will be described. The control unit 13 according to the seventh embodiment controls the virtual image distance of the warning object (the symbol warning object and the character warning object) to be aligned with the calculated distance. In the example of FIG. 20B, the calculated distance of the person 87s is 20 m, and therefore the control unit 13 sets virtual image distances of the symbol warning object 82s1 and the character warning object 82s2 of the person 87s at 20 m. In the example of FIG. 21B, the calculated distance of the person 87s is 100 m, and therefore the control unit 13 sets virtual image distances of the symbol warning object 82s3 and the character warning object 82s4 of the person 87s at 100 m.

Incidentally, in the examples of FIG. 20B and FIG. 21B, irrespective of the calculated distance, a difference in virtual image distance between the symbol warning object 82s1 and the character warning object 82s2 and a difference in virtual image distance between the symbol warning object 82s3 and the character warning object 82s4 are both 0 m, and thus the differences are the same. However, the difference in virtual image distance between the symbol warning object 82s1 and the character warning object 82s2 has only to be the same irrespective of the calculated distance, and therefore is not limited to 0.

### Conclusion of Seventh Embodiment

In the display device 2 according to the seventh embodiment such as that described above, the display size of the symbol warning object of the attention target object and the display size of the character warning object of the attention target object are individually controlled on the basis of the calculated distance. In addition, the virtual image display unit 21 is controlled in such a manner that a degree to which the display size of the character warning object decreases with the increase in calculated distance becomes smaller than a degree to which the display size of the symbol warning object decreases with the increase in calculated distance. Such a configuration causes the display size of the symbol warning object to decrease with the increase in distance between the own vehicle and the attention target object, and therefore the symbol warning object that fits the sense of the driver can be displayed. Meanwhile, the display size of the character warning object is relatively hard to be decreased, and therefore it is possible to suppress a decrease in visibility of characters of the character warning object.

Incidentally, the above description has been made on the assumption that the display size of the character warning object does not change irrespective of the change in the calculated distance. However, the present invention is not limited to this. On the condition that the degree to which the display size of the character warning object decreases with the increase in calculated distance is smaller than the degree to which the display size of the symbol warning object decreases with the increase in calculated distance, the display size of the character warning object may be changed according to the change in the calculated distance.

In addition, in FIGS. 20A and 20B, a warning object is displayed on the traveling direction side of a walker (the person 87s) who intends to move from the right side to the left side. Displaying the warning object on the traveling direction side in this manner enables to inform the driver which direction is risky for the walker (the person 87s).

### FIFTH MODIFIED EXAMPLE

In the present seventh embodiment, the control unit 13 individually controls the display size of the symbol warning object, and the display size of the character warning object. Meanwhile, in the fifth modified example, the control unit 13 individually controls the virtual image distance of the symbol warning object, and the virtual image distance of the character warning object. More specifically, the control unit 13 performs the above-described control in such a manner that the virtual image distance of the character warning object is smaller than or equal to the virtual image distance of the symbol warning object.

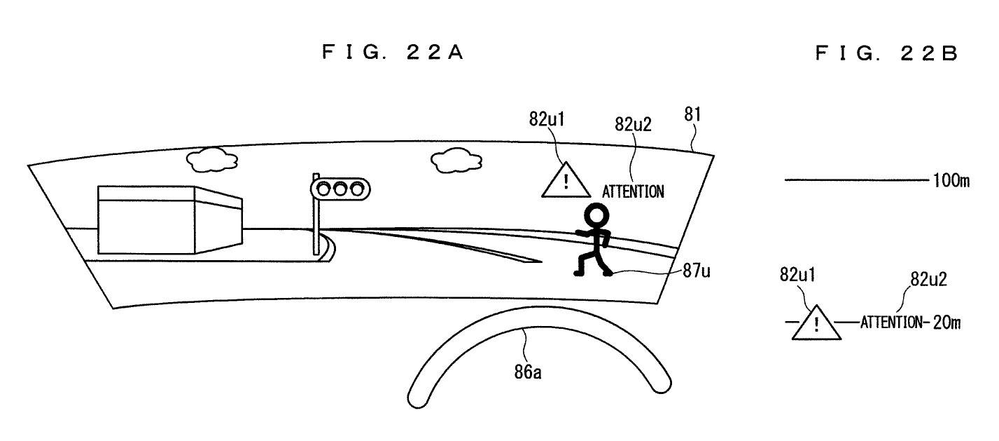

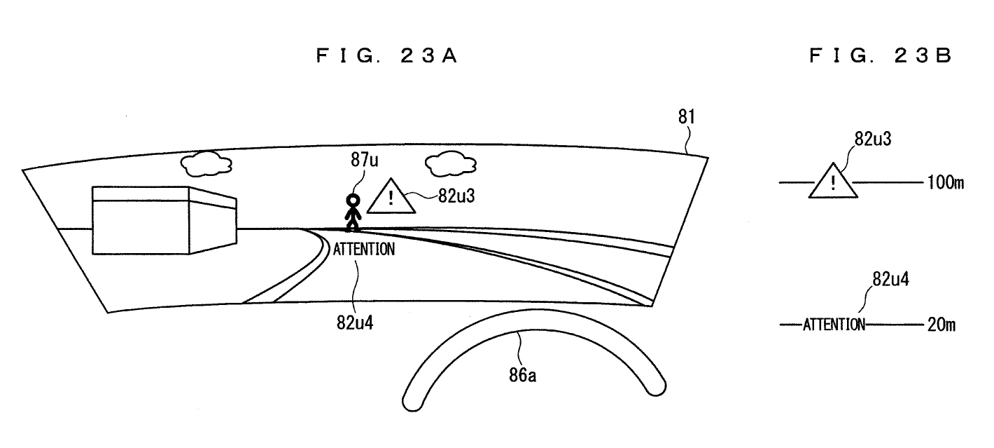

FIGS. 22A and 22B are drawings illustrating an example of displaying by the display device 2 according to the fifth modified example in a case where a distance between the own vehicle and a person 87u is 20 m. Meanwhile, FIG. 23 is a drawing illustrating an example of displaying by the display device 2 according to the fifth modified example in a case where a distance between the own vehicle and the person 87u is 100 m. Incidentally, the fifth modified example will be described on the assumption that display sizes of the symbol warning object and the character warning object do not change irrespective of the change in the calculated distance.

The control unit 13 according to the fifth modified example controls a virtual image distance of a symbol warning object to be aligned with a calculated distance in a manner similar to that of the seventh embodiment. In the example of FIG. 22B, the calculated distance of the person 87u is 20 m, and therefore the control unit 13 sets a virtual image distance of the symbol warning object 82u1 of the person 87u at 20 m. In the example of FIG. 23B, the calculated distance of the person 87u is 100 m, and therefore the control unit 13 sets a virtual image distance of the symbol warning object 82u3 of the person 87u at 100 m. Meanwhile, the control unit 13 makes virtual image distances of the character warning objects 82u2, 82u4 constant (for example, 10 m) irrespective of the change in the calculated distance of the person 87u.

In the display device 2 according to the fifth modified example such as that described above, the virtual image distance of the symbol warning object of the attention target object and the virtual image distance of the character warning object of the attention target object are individually controlled on the basis of the calculated distance. In addition, the virtual image display unit 21 is controlled in such a manner that the virtual image distance of the character warning object becomes smaller than or equal to the virtual image distance of the symbol warning object. Using such a configuration enables to adequately alert a driver to a character warning object.

Incidentally, in the above-description, the virtual image distance of the character warning object is fixed to a constant value. However, the present invention is not limited to this. On the condition that the virtual image distance of the character warning object is smaller than or equal to the virtual image distance of the symbol warning object, the virtual image distance of the character warning object may be changed according to the change in the calculated distance.

In addition, the seventh embodiment may be combined with the fifth modified example described above. In other words, the above-described control may be performed in such a manner that the degree to which the display size of the character warning object decreases with the increase in calculated distance becomes smaller than the degree to which the display size of the symbol warning object decreases with the increase in calculated distance, and in such a manner that the virtual image distance of the character warning object becomes smaller than or equal to the virtual image distance of the symbol warning object.

Moreover, when a virtual image distance of the character warning object is controlled, the virtual image distance may be provided with an upper limit value. Furthermore, this upper limit value may be changed on the basis of criteria such as a traveling speed.

### Eighth Embodiment

A block diagram of a display device according to an eighth embodiment of the present invention is similar to the block diagram (FIG. 3) of the display device according to the second embodiment. In the description below, the display device 2 according to the present eighth embodiment uses the same reference numerals to denote components that are the same as, or similar to, those in the second embodiment, and components different therefrom will be mainly described. It should be noted that the information acquisition unit 11, the display object storage unit 12, and the control unit 13 according to the present eighth embodiment may have, or do not have to have, the same functions as those of the second embodiment.

In the present eighth embodiment, it is assumed that an attention target is an expressway attention target point, and attention information is a relative position of an expressway attention target point with respect to the own vehicle. In this case, as described in the first embodiment, the information acquisition unit 11 acquires (generates) attention information that includes relative positions, with respect to the own vehicle, of two or more specific attention target objects, at which the own vehicle can arrive by traveling along a guide route, among a plurality of attention target points. In addition, the attention target is an expressway attention target point, and therefore the control unit 13 according to the eighth embodiment causes the virtual image display unit 21 to display a signboard object as a corresponding display object.

In addition, in the present eighth embodiment, the control unit 13 calculates a distance between the own vehicle and each expressway attention target point on the basis of the relative positions of the two or more expressway attention target points included in the attention information acquired by the information acquisition unit 11. It should be noted that when the information acquisition unit 11 is capable of acquiring map information, the control unit 13 may calculate the above-described distance in consideration of a shape and the like of the route.

In addition, the control unit 13 controls a virtual image distance of a signboard object of each expressway attention target point on the basis of the calculated distance that is the distance that has been calculated. More specifically, the virtual image distance is controlled in such a manner that the virtual image distance of the first signboard object (the first corresponding display object) becomes lower than or equal to the virtual image distance of the second signboard object (the second corresponding display object), the calculated distance of which is longer than that of the first signboard object. Incidentally, in the present eighth embodiment, it is assumed that the second signboard object indicates a simplified drawing, a road traffic sign or the like of an expressway, related to a plurality of expressway attention target points other than the expressway attention target point, the calculated distance of which is the shortest.

In addition, in the present eighth embodiment, the virtual image direction is controlled in such a manner that the first signboard object is displayed in a central part (corresponding to a central part of the windshield 81) of the displayable area of the virtual image display unit 21 in comparison with the second signboard object, the calculated distance of which is longer than that of the first signboard object.

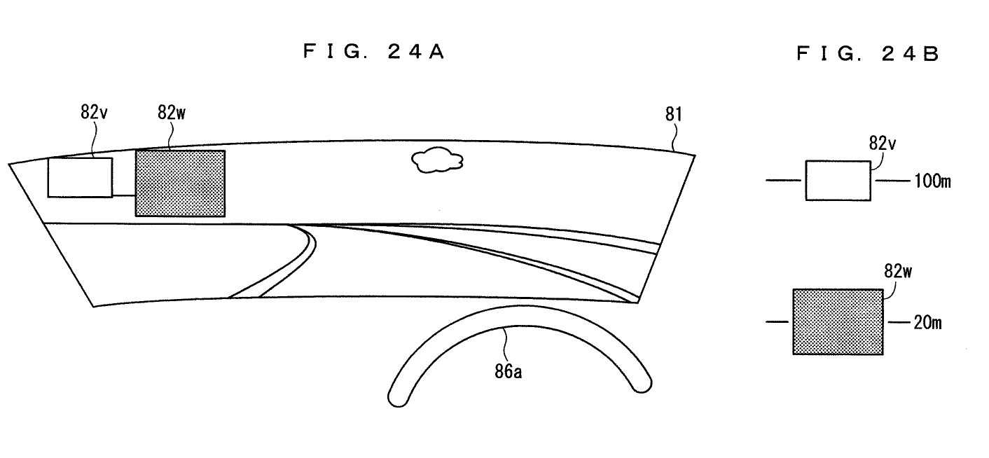

FIGS. 24A and 24B are drawings illustrating an example of displaying by the display device 2 according to the present eighth embodiment. As shown in FIG. 24A and FIG. 24B, the control unit 13 lengthens the virtual image distance of the second signboard object 82v (for example, 100 m) of points other than the expressway attention target point, the calculated distance of which is the shortest, and shortens the virtual image distance of the first signboard object 82w (for example, 50 m) of the expressway attention target point, the calculated distance of which is the shortest. In other words, the control unit 13 makes the virtual image distance of the first signboard object 82w shorter than or equal to the virtual image distance of the second signboard object 82v. In addition, the control unit 13 controls the virtual image display unit 21 in such a manner that the first signboard object 82w is displayed in the central part of the displayable area of the virtual image display unit 21 in comparison with the second signboard object 82v.

### Conclusion of Eighth Embodiment

In the display device 2 according to the eighth embodiment such as that described above, a virtual image distance of a signboard object of each expressway attention target point is controlled on the basis of the calculated distance. In addition, the virtual image display unit 21 is controlled in such a manner that the virtual image distance of the first signboard object becomes shorter than or equal to the virtual image distance of the second signboard object, the calculated distance of which is longer than that of the first signboard object. This enables to adequately alert a driver to an expressway attention target point close to the own vehicle among expressway attention target points that cannot be seen from the driver of the own vehicle.

Incidentally, in the example shown in FIGS. 24A and 24B, the size of the first signboard object 82w of an expressway attention target point that is relatively close to the own vehicle is made larger than the size of the second signboard object 82v. Changing the size in this manner enables to display a signboard object that fits the sense of the driver.

### SIXTH MODIFIED EXAMPLE

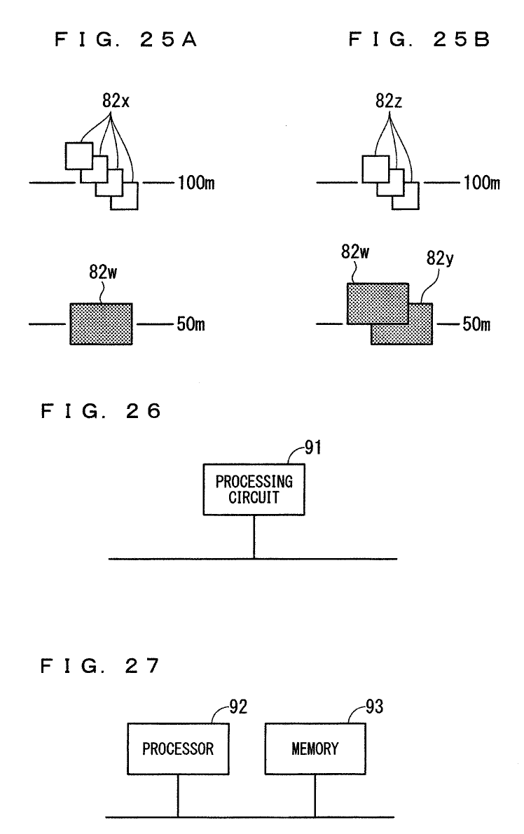

In the eighth embodiment, the second signboard object 82v indicates a simplified drawing, a road traffic sign or the like of an expressway, related to a plurality of expressway attention target points other than the expressway attention target point, the calculated distance of which is the shortest. However, the present invention is not limited to this. As shown in FIG. 25A, a plurality of second signboard objects 82x may each indicate a simplified drawing, a road traffic sign or the like of an expressway at a plurality of expressway attention target points other than the expressway attention target point, the calculated distance of which is the shortest, respectively.

In addition, in the eighth embodiment, the control unit 13 shortens the virtual image distance of the first signboard object 82w of the expressway attention target point, the calculated distance of which is the shortest, and lengthens virtual image distances of the other expressway attention target points. However, the present invention is not limited to this. When the expressway attention target point, the calculated distance of which is the shortest, and the expressway attention target point, the calculated distance of which is the second shortest, are, for example, close to the own vehicle, the control unit 13 may make the virtual image distance of the first signboard object 82w at the expressway attention target point, the calculated distance of which is the shortest, and the virtual image distance of the second signboard object 82y at the expressway attention target point, the calculated distance of which is the second shortest, short (for example, 50 m) as shown in FIG. 25B. In addition, the control unit 13 may make the virtual image distance of the second signboard object 82z at the other expressway attention target points long (for example, 100 m).

### OTHER MODIFIED EXAMPLES

The information acquisition unit 11 and the control unit 13 (hereinafter referred to as “information acquisition unit 11 and the like”) in the above-described display control apparatus 1 are realized by a processing circuit 91 shown in FIG. 26. In other words, the processing circuit 91 is provided with: the information acquisition unit 11 for acquiring attention information that includes at least any one of a property of an attention target to which a driver of the traveling own vehicle that is traveling should be alerted, a relative position and a relative direction, with respect to a traveling vehicle, of the attention target; and the control unit 13 for controlling, on the basis of the acquired attention information, at least a virtual image distance from between the virtual image distance and a virtual image direction of a corresponding display object, which is a display object corresponding to the attention target, as a control of displaying by the virtual image display unit 21. Dedicated hardware may be applied to the processing circuit 91, or a processor (Central Processing Unit, a central processor, a processing unit, an arithmetic unit, a microprocessor, a microcomputer, Digital Signal Processor) that executes a program stored in a memory may be applied to the processing circuit 91.

When the processing circuit 91 is dedicated hardware, for example, a single circuit, a composite circuit, a programmed processor, a parallel-programmed processor, ASIC, FPGA, or a combination of the above is applicable to the processing circuit 91. Functions of components that are the information acquisition unit 11 and the like may be each realized by the plurality of processing circuits 91, or may be realized by one processing circuit 91 into which the functions of the components are integrated.

When the processing circuit 91 is a processor, functions of the information acquisition unit 11 and the like are realized by a combination of software and the like (software, firmware, or software and firmware). The software and the like are described as a program, and are stored in a memory. As shown in FIG. 27, the processor 92 that is applied to the processing circuit 91 realizes a function of each component by reading a program stored in a memory 93, and then by executing the program. In other words, the display control apparatus 1 is provided with the memory 93 for storing a program that, when being executed by the processing circuit 91, consequently causes execution of: a step of acquiring attention information that includes at least any one of a property of an attention target to which a driver of the traveling own vehicle that is traveling should be alerted, a relative position and a relative direction, with respect to a traveling vehicle, of the attention target; and a step of controlling, on the basis of the acquired attention information, at least a virtual image distance from between the virtual image distance and a virtual image direction of a corresponding display object that is a display object corresponding to the attention target. In other words, it can also be said that this program causes a computer to execute a step or a method of the information acquisition unit 11 and the like. Here, for example, a non-volatile or volatile semiconductor memory such as a RAM (Random Access Memory), a ROM (Read Only Memory), a flash memory, an EPROM (Erasable Programmable Read Only Memory), and an EEPROM (Electrically Erasable Programmable Read Only Memory), a HDD (Hard Disk Drive), a magnetic disk, a flexible disk, an optical disk, a compact disk, a Mini-Disk, a DVD (Digital Versatile Disc), and drive units thereof, are applicable to the memory 93.

The configuration in which the functions of the information acquisition unit 11 and the like are each realized by any one of hardware, software and the like has been described as above. However, the present invention is not limited to this. A configuration in which a part of the information acquisition unit 11 and the like is realized by dedicated hardware, and another part is realized by software may be used. For example, a processing circuit as dedicated hardware can be used to realize the function of the control unit 13, and the processing circuit 91 as the processor 92 is caused to read a program stored in the memory 93, and then to execute the program, thereby enabling to realize the other functions.

As described above, the processing circuit 91 is capable of realizing each of the above-described functions by hardware, software or the like, or a combination thereof. It should be noted that although the display object storage unit 12 is configured from the memory 93, the display object storage unit 12 may be configured from one memory 93, or each may be configured from the individual memory 93.

In addition, the display control apparatus described above can be applied to a display control system that is built as a system by combining a vehicle-mountable navigation device that is mounted to a vehicle, a Portable Navigation Device, a communication terminal (for example, a mobile terminal such as a portable telephone, a smart phone, and a tablet), an application function installed therein, and a server and the like as appropriate. In this case, functions or components of the display control apparatus described above may be each arranged in a distributed manner in each apparatus that builds the system, or may be arranged in any of apparatuses in a centralized manner.

It should be noted that in the present invention, the embodiments and the modified examples may be freely combined, and each embodiment and each modified example may be modified or omitted as appropriate, within the scope of the invention.

The present invention has been described in detail. However, the description above is illustrative in all respects, and thus the present invention is not limited thereto. It is construed that an infinite number of modified examples which are not illustrated can be assumed without departing from the scope of the present invention.

### REFERENCE SIGNS LIST

1: Display control apparatus

2: Display device

11: Information acquisition unit

13: Control unit

21: Virtual image display unit

81: Windshield

82: Display object

82a, 82b, 82c, 82e, 82f, 82j, 82k, 82l, 82n, 82o, 82p, 82q: Warning object

82s1, 82s3, 82u1, 82u3: Symbol warning object

82s2, 82s4, 82u2, 82u4: Character warning object

82v, 82w, 82x, 82y, 82z: Signboard object

84: Displayable area

86: Own vehicle

91: Processing circuit

92: Processor

93: Memory

1. A display control apparatus that controls a virtual image display unit,
said virtual image display being capable of displaying a display object, which is a virtual image that can be visually recognized from a driver seat of a vehicle through a windshield of said vehicle, at a virtual image position that is defined by a virtual image direction that is a direction of said virtual image with respect to a specific position of said vehicle, and by a virtual image distance that is a distance to said virtual image, with respect to said specific position
the display control apparatus comprising:
an information receiver for acquiring attention information that includes at least any one of a property of an attention target to which a driver of said vehicle that is traveling should be alerted, a relative position and a relative direction, with respect to said vehicle, of said attention target; and
a controller for controlling displaying by said virtual image display,
wherein said controller controls, on the basis of said attention information acquired by said information receiver, at least said virtual image distance from between said virtual image distance and said virtual image direction of a corresponding display object that is said display object corresponding to said attention target.

2. The display control apparatus according to claim 1, wherein
said attention information includes a relative position or a relative direction of said attention target around said vehicle, and
said controller increases said virtual image distance of said corresponding display object with a decrease in angle formed by a forward direction of said vehicle and said relative direction based on said attention information acquired by said information receiver.

3. The display control apparatus according to claim 1, wherein
said attention information includes a relative position or a relative direction of said attention target around said vehicle, and
when it is determined, on the basis of said attention information acquired by said information receiver that a position of said attention target viewed from said driver seat is outside a displayable area of said virtual image display, said controller controls said virtual image display in such a manner that said corresponding display object of the attention target is displayed in an end part of said displayable area.

4. The display control apparatus according to claim 1, wherein
said information receiver further acquires a color and a hue of said attention target, and
said controller causes a color and a hue of said corresponding display object to correspond to the color and the hue of said attention target acquired by said information receiver.

5. The display control apparatus according to claim 1, wherein
said attention information includes, as a property of said attention target, an attention degree indicating a degree to which said driver should be alerted to said attention target around said vehicle, and
said controller controls said virtual image distance of said corresponding display object on the basis of said attention degree included in said attention information acquired by said information receiver.

6. The display control apparatus according to claim 5, wherein
said attention degree of attention to said attention target increases with an increase in influence exerted on a human body when the vehicle hits said attention target.

7. The display control apparatus according to claim 1, wherein
said information receiver further acquires a traveling direction of said vehicle,
said attention information includes a relative position or a relative direction of said attention target around said vehicle, and
said controller determines, on the basis of said attention information and said traveling direction acquired by said information receiver, whether or not said attention target influences traveling of said vehicle, and makes said virtual image distance of said corresponding display object of said attention target that has been determined to influence shorter than said virtual image distance of said corresponding display object of said attention target that has not been determined to influence.

8. The display control apparatus according to claim 1, wherein
said information receiver further acquires a traveling direction of said vehicle, a current position of said vehicle, and map information in which specific road points including an intersection and a pedestrian crossing are set
said attention information includes a relative position or a relative direction of said attention target around said vehicle, and
when it is determined, on the basis of said attention information, said traveling direction, said current position and said map information that have been acquired by said information receiver, that said attention target exists in proximity to said specific road point through which said vehicle travels or is traveling, said controller makes said virtual image distance of said corresponding display object of said attention target that has been determined to exist in proximity to said specific road point shorter than said virtual image distance of said corresponding display object of said attention target that has not been determined to exist in proximity to said specific road point.

9. The display control apparatus according to claim 1, wherein
said information receiver acquires said attention information that includes, as a relative position or a relative direction of said attention target, a relative position or a relative direction, with respect to said vehicle, of said attention target point around said vehicle among a plurality of attention target points set beforehand as points to which said driver should be alerted.

10. The display control apparatus according to claim 1, wherein
said information receiver acquires said attention information for each of the plurality of attention targets, and
said controller individually controls said virtual image distance of each of said corresponding display object of each of said attention target on the basis of said attention information of said plurality of attention targets acquired by said information receiver.

11. The display control apparatus according to claim 1, wherein
said corresponding display object includes a symbol warning object and a character warning object,
said attention information includes a relative position of said attention target around said vehicle, and
said controller calculates a distance between said vehicle and said attention target on the basis of the relative position included in said attention information acquired by said information receiver, and individually controls, on the basis of said distance, at least any one of a display size and said virtual image distance of said symbol warning object of said attention target, and said at least any one of said character warning object of said attention target.

12. The display control apparatus according to claim 11, wherein
said controller individually controls, on the basis of said distance, said display size of said symbol warning object of said attention target, and said display size of said character warning object of said attention target,
a difference in said virtual image distance between said symbol warning object and said character warning object is the same irrespective of said distance, and
a degree to which said display size of said character warning object decreases with an increase in said distance is smaller than a degree to which said display size of said symbol warning object decreases with an increase in said distance.

13. The display control apparatus according to claim 11, wherein
said controller individually controls, on the basis of said distance, said virtual image distance of said symbol warning object of said attention target, and said virtual image distance of said character warning object of said attention target, and
said virtual image distance of said character warning object is shorter than or equal to said virtual image distance of said symbol warning object.

14. The display control apparatus according to claim 1, wherein
said information receiver acquires said attention information that includes, as relative positions of two or more said attention targets, relative positions, with respect to said vehicle, of two or more attention target points, at which said vehicle can arrive by traveling along a guide route, among a plurality of attention target points set beforehand as points to which said driver should be alerted, and
said controller calculates a distance between said vehicle and each of said attention target on the basis of the relative positions of said two or more attention target points included in said attention information acquired by said information receiver, and controls at least said virtual image distance of said corresponding display object of each of said attention target point on the basis of a calculated distance that is the distance that has been calculated.

15. The display control apparatus according to claim 14, wherein
said virtual image distance of a first corresponding display object that is one of said corresponding display object is shorter than or equal to said virtual image distance of a second corresponding display object that is another of said corresponding display object, said calculated distance of said second corresponding display object being longer than said calculated distance of said first corresponding display object.

16. The display control apparatus according to claim 14, wherein
said controller controls said virtual image display in such a manner that a first corresponding display object that is one of said corresponding display object is displayed in a central part of a displayable area of said virtual image display in comparison with a second corresponding display object that is another of said corresponding display object, said calculated distance of said second corresponding display object being longer than said calculated distance of said first corresponding display object.

17. The display control apparatus according to claim 14, wherein
said attention target point includes an interchange, a junction, a service area, or a parking area, of an expressway.

18. A display device comprising:
the display control apparatus set forth in claim 1; and
said virtual image display.

19. A display control method for controlling a virtual image display,
said virtual image display being capable of displaying a display object, which is a virtual image that can be visually recognized from a driver seat of a vehicle through a windshield of said vehicle, at a virtual image position that is defined by a virtual image direction that is a direction of said virtual image with respect to a specific position of said vehicle, and by a virtual image distance that is a distance to said virtual image, with respect to said specific position
said display control method comprising:
acquiring attention information that includes at least any one of a property of an attention target to which a driver of said vehicle that is traveling should be alerted, a relative position and a relative direction, with respect to said vehicle, of said attention target; and
controlling, on the basis of said acquired attention information, at least said virtual image distance from between said virtual image distance and said virtual image direction of a corresponding display object that is said display object corresponding to said attention target.
